(19) United States
(12) Patent Application Publication
(10) Pub. No.: US 2007/0124278 A1
(43) Pub. Date: May 31, 2007

(54) System and method for electronic record keeping

(75) Inventors: William E. Lewis JR., Attleboro, MA (US); Deborah Kinch, Billerica, MA (US); Brian E. Watson, Derry, NH (US)

Correspondence Address: STEPTOE & JOHNSON LLP, 1330 CONNECTICUT AVE., NW, WASHINGTON, DC, 20036, US

(73) Assignee: Biogen Idec MA Inc., Cambridge, MA (US)

(21) Appl. No.: 11/589,064

(22) Filed: Oct. 30, 2006

Related U.S. Application Data
(60) Provisional application No. 60/731,467, filed on Oct. 31, 2005.

(51) Int. Cl. G06F 17/30

(52) U.S. Cl. 707/2

(57) ABSTRACT

A system and method of keeping records includes recording information and metadata associated with the information. The metadata is protected from changes. The information can be displayed to a second user for acknowledgement. Acknowledgement by the second user can also be recorded. The metadata can provide an audit trail for reviewing additions, deletions and changes to the records.

### CLAIM OF PRIORITY

This application claims priority to provisional U.S. application no. 60/731,467, filed Oct. 31, 2005, which is hereby incorporated by reference in its entirety.

### TECHNICAL FIELD

The invention relates to systems and methods for electronic record keeping.

### BACKGROUND

Record-keeping for multistep, complex sample processing methods can be challenging, particularly where the records are needed to support Good Laboratory Practice (GLP) compliant studies. The complex nature of this workflow makes sample and data traceability difficult, putting data integrity at risk. Existing GLP-compliant electronic record keeping systems can be inadequate for meeting the needs of a multistep, complex sample processing method.

### SUMMARY

A system and method for electronically recording, storing, and maintaining records are provided. In particular, the records can be records of experiments in a drug or biological development context, such as, for example, research, preclinical, clinical, or product development experiments. The system and method can provide electronic data-entry forms, automate formula-based calculations, verify reagents and protocols, accommodate witness review, and support reporting requirements within an organization or for regulations.

The system can support compliance with 21 CFR part 11, which allows the system to be used in a GLP environment as required for the processing and analysis of samples performed as part of preclinical safety studies. The system can have numerous built-in validation rules to insure adherence to laboratory processes and data integrity, throughout the process(for example, from sample selection to data generation). The system can also have a full audit trail. The system and method can be adapted to any workflow within a laboratory group, such as, for example a sample processing workflow for gene expression profiling experiments. The system can support a single point of data entry (for example, an upstream LIMS) and a single point of data storage. Electronic forms can be used for recording all laboratory processes. The system and method can be easily deployed to multiple sites (e.g., laboratories in different buildings, different cities, or even different countries). By using a single system deployed remotely at multiple locations, workflow and record keeping at the various locations can be integrated.

The system can incorporate fully traceable challenge/response tracking. More specifically, a worker can record his or her actions in the system. The worker's records can be subsequently reviewed by another individual (e.g., another worker or a supervisor). If the reviewer finds any errors, discrepancies, inconsistencies or other issues with the records, the review can enter a comment in the record and request the worker to explain the record. Because the records can be securely stored in an electronic format, the system can provide an institutional memory, which can be reviewed long after records were made and individuals who created the records are no longer with the institution.

Advantageously, the system and method can be adapted to complex, multistep workflows. For example, the system and method can be configured to record, store, and maintain records (in a computer-readable format) related to gene expression profiling experiments performed in a drug discovery or development context. The computer-readable records can be used to produce reports or reformat the records in a convenient format. The reports can be useful for lab management or regulatory compliance purposes.

In one aspect, a method of keeping records includes recording on a computer-readable medium information entered by a first user to provide a first computer-readable record, and metadata associated with the first computer-readable record. The metadata is protected from changes. The first computer-readable record is displayed to a second user for acknowledgement. The acknowledgement by the second user of the information entered by the first user is recorded on a computer-readable medium.

In another aspect, a computer program for record-keeping includes instructions for causing a computer system to record on a computer-readable medium information entered by a first user to provide a first computer-readable record and metadata associated with the first computer-readable record. The metadata is protected from changes. The computer system displays the first computer-readable record to a second user for acknowledgement; and records, on a computer-readable medium, an acknowledgement by the second user of the information entered by the first user.

Recording the acknowledgement can include recording an approval or disapproval of the information entered by the first user. The acknowledgement can include a comment by the second user. Recording a disapproval can include requiring the second user to record a comment. The metadata associated with the first computer-readable record can include an identity of the first user, a date, a time, or a combination thereof.

The information entered by the first user includes information that can describe a laboratory manipulation carried out by the first user. The laboratory manipulation can be performed according to a standard operating procedure. The standard operating procedure can specify mandatory information describing the laboratory manipulation that must be recorded in order to comply with the standard operating procedure. The first user can be required to enter the mandatory information.

The information describing a laboratory manipulation can include a user identity, a sample identity, a sample description, an identity of a standard operating procedure, a version of a standard operating procedure, an equipment identity, a reagent identity, a reagent manufacturer, a reagent expiration date, a reagent amount, a reagent quantity, a start time of a manipulation, a stop time of a manipulation, a duration of a manipulation, an amplitude of a manipulation, a result of a measurement, an identity of a manipulated sample, a location of a manipulated sample, a user comment, or a combination thereof.

In general, a laboratory manipulation can be any manipulation that is defined by a series of steps performed in a laboratory. A laboratory manipulation can include preparation, processing or measurement of a reagent, such as, for example, solutions, solvents, solutes, inorganic compounds, organic compounds, or biochemicals (e.g., a nucleic acid, protein, enzyme); preparation, processing or measurement of biological material (e.g., animals, plants, tissues, or cells); preparation, processing or measurement of biochemicals, whether isolated from a biological source or produced synthetically (e.g, proteins, nucleic acids, lipids, carbohydrates or their components, such as nucleotides or amino acids, or other metabolites). Processing can include (without limitation) mixing (e.g, by manual or magnetic stirring, rotary shaker, or vortex), separating (e.g., filtration or centrifugation), purifying (e.g., by chromatography), homogenizing, heating, cooling, incubating, precipitating, dissolving, concentrating, diluting, or a combination thereof. Measurement includes observing, determining or detecting a property of a material, manually or with the aid of instrumentation. Measurement can include subsequent data processing or analysis of raw measurements. Some common measurements include, without limitation, measurements of volume, mass, temperature, pH, and spectral properties (i.e., measurement of an absorption, transmittance, or fluorescence spectrum).

The manipulation can be carried out in the context of basic research, clinical research, product development, manufacturing, quality assurance, quality control, or another context. A manipulation can be performed by a person, by more than one person, or in some cases, by automated equipment. The laboratory manipulation can include a manipulation related to a nucleic acid preparation, a nucleic acid purification, a nucleic acid labeling, a protein preparation, a protein purification, a protein labeling, a metabolite preparation, a metabolite purification, or a metabolite labeling. In some cases, the manipulation is related to a gene expression profiling experiment, an ELISA-based assay, a cell-based assay, a flow cytometry assay, a multiplex bead-based assay, a proteomics assay, a PCR-based assay, a spectrophotometric analysis, a gel electrophoresis experiment, a capillary electrophoresis experiment, or a combination thereof. The laboratory manipulation can include a manipulation related to tissue homogenization, total RNA preparation, cRNA preparation, or hybridization of cRNA to a DNA array.

The method can include recording on a computer-readable medium a comment from the first user when the second user disapproves of the first electronic record. The method can include submitting the first computer-readable record to a regulatory agency. The method can include recording on a computer-readable medium information entered by a first user to provide a second computer-readable record and metadata associated with the second computer-readable record to provide a collection of computer-readable records. The metadata is protected from changes. The collection of computer-readable records can be displayed to a second user for acknowledgement. The collection of computer-readable records can describe a laboratory workflow.

The method can include modifying the collection by recording on a computer-readable medium a third computer-readable record and metadata associated with the third computer-readable record. The third computer-readable record corresponds to and modifies an existing computer-readable record in the collection. The existing computer-readable record and its associated metadata are retained in the collection. The method can further include recording on a computer-readable medium information entered by a first user to provide a plurality of computer-readable records and metadata associated with the each of the plurality of computer-readable records to provide a collection of computer-readable records. The method can include generating an audit trail for the collection of computer-readable records from the metadata.

In another aspect, a system for record-keeping includes a computer system and a laboratory instrument. The computer system is configured to record on a computer-readable medium a plurality of information entered by a first user to provide a plurality computer-readable records, and metadata associated with the plurality of computer-readable records. The information describes a laboratory manipulation carried out by the first user, and the metadata is protected from changes. The computer system displays at least one of the plurality of computer-readable records to a second user for acknowledgement, and records, on a computer-readable medium, an acknowledgement by the second user of information entered by the first user. The laboratory instrument is in communication with the computer system, and is configured to communicate a result of a measurement to the computer system.

The computer system can be further configured record the result on the computer-readable medium to provide a second computer-readable record, and metadata associated with the second computer-readable record. The metadata is protected from changes. The laboratory instrument can include a balance, a spectrophotometer, a spectrofluorometer, a centrifuge, a barcode reader, or a pipettor. The laboratory instrument can include a nucleic acid array reader.

The laboratory manipulation can be performed according to a standard operating procedure. The standard operating procedure specifies mandatory information describing the laboratory manipulation that must be recorded in order to comply with the standard operating procedure. The first user can be required to enter the mandatory information. The computer system can analyze the result. The computer system can generate an audit trail for the plurality of computer-readable records from the metadata. The computer system can format at least one of the plurality of computer-readable records for review by a regulatory agency. The computer system can generate a report summarizing the plurality of computer-readable records. The computer system can store the report in an archive.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a block diagram illustrating a laboratory workflow and corresponding form completion and witnessing.

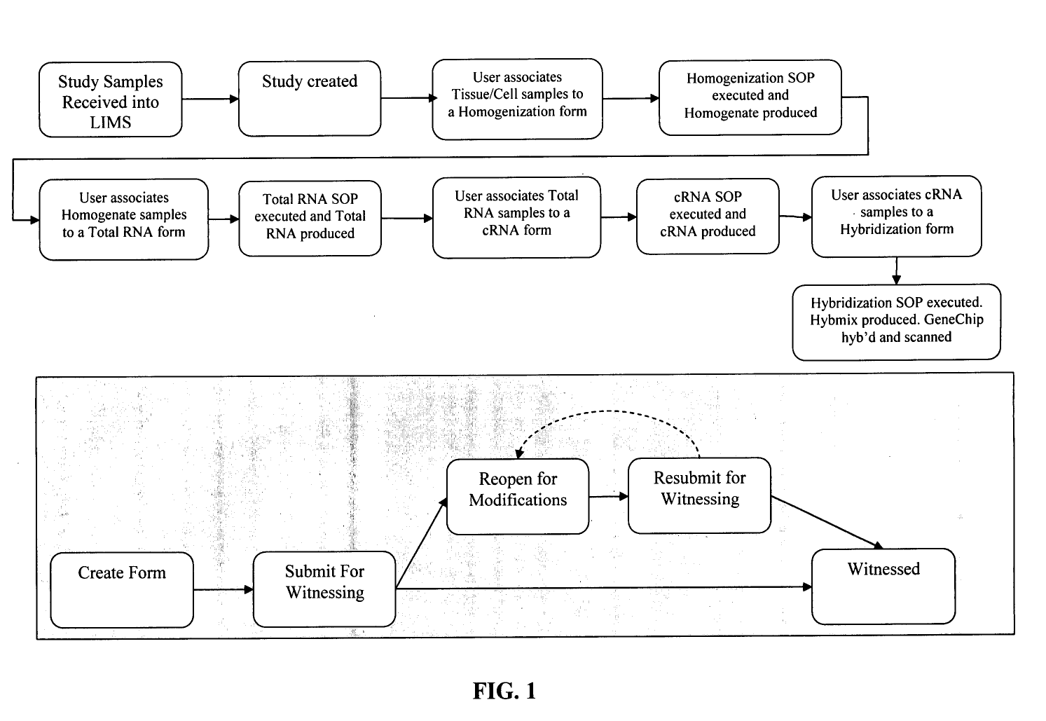

FIG. 2 is a schematic diagram depicting a system architecture for a record keeping system.

FIG. 3 is a schematic diagram depicting a technology stack used by the various components of a record keeping application.

### DETAILED DESCRIPTION

In order to comply with GLP (e.g., 21 CFR Part 11), a system and method can be configured to address issues of data integrity, data and system security, enforcement of workflow and procedure, and record integrity.

To ensure data integrity, the system and method can support creation of an audit trail. An audit trail is created to allow the detection of altered records. Data files can be protected against intentional or accidental modification or deletion. The system can generate automatic, electronic audit trail information for all operator entries and actions that create, modify, or delete records. Audit trail generation can be completely transparent to, and outside the control and access of, users. The audit trail function can always be active. The audit trail can include metadata associated with records. Metadata describes the records, indicating, for example, user identification, date, time (to the second), and an indication of record creation, modification, or deletion for each record. When records are changed or deleted, the previous data can be maintained. The audit trail data can be protected from accidental or intentional modification or deletion. Electronic audit trails are readily available for review and copying, for example, by a regulatory agency.

To provide data and system security, the system and method can have backup and restore processes, to protect against, for example, accidental data losses. The system can have data archiving and retrieval processes. The system can have system security, including physical, logical, and procedural controls. The system can contain different levels of access based on user responsibilities. The levels of access can be documented and controlled. The system can be configured to verify that an individual's authorization to access a system or application before it allows them into the system or application. The system can verify that an individual has the appropriate privileges to perform specific functions within a system or application before allowing them to do so.

In order to enforce workflow and procedure, the system and method can be configured to ensure that any sequences of operations, sequential events, or sequential data entry that are important to the workflow are followed in the correct sequence.

Date and time stamps in records can be applied automatically, rather than keyed in by the user, to ensure the integrity of the records, and guard against keystroke errors.

In general, the system and method are used to record experimental details in an electronic format. The system and method can be configured for use with an experimental workflow. An experimental workflow is a series of steps required to execute a desired experiment. Some non-limiting examples of experimental workflows that can be used with the system include:
preparation or purification of proteins, nucleic acids, or metabolites;
gene expression profiling experiments;
ELISA based assays from animal samples (e.g., serum, urine, CSF, bodily fluids, or tissues) or in vitro samples to measure pharmacokinetics, antibody levels, or analyte levels;
cell based assay formats (e.g., treatment of in vitro cells with stimulus) to measure cell surface receptor levels, cellular metabolism (e.g., apoptosis, lysis) or cellular activity (e.g., signaling, reporter genes);
flow cytometry assays from in vitro samples or in vivo samples to measure cell surface receptors, intracellular proteins, mRNAs, and the like;
multiplex bead-based assays to measure analytes in serum or from in vitro experiments;
proteomics assays including LC/MS, MS/MS, or protein arrays;
a metabolomics assay;
PCR-based assays for genotyping, gene expression, immuno-based PCR assays, for in vitro or in vivo samples;
spectrophotometric analysis of DNA, RNA, or protein for purity, concentration, and integrity; or
gel or capillary electrophoresis for analysis of nucleic acids and protein.

For example, a gene expression profiling workflow can include homogenization of a tissue sample, preparation of total RNA, preparation of cRNA, preparation of a hybridization mix (hyb mix), and hybridization of the hyb mix to an array of nucleic acids (e.g., a GENECHIP). Each step in the workflow can involve the use of samples, equipment, reagents, and so on. A user can input information related to the sample, equipment, reagents, and so on, to be recorded by the system. The system can also calculate and record information based on user input. For example, the system can calculate and record an amount of reagent to be used based on user input. The calculation can be based on a formula, e.g., a formula defined in a SOP.

The system and method can support witnessing of records by witnessor. Witnessing of forms allows for a performer's entries to be reviewed and optionally commented on by another individual. A performer is prohibited from witnessing his or her own records. If the witnessor disagrees with a performer's records, the witnessor can comment on the records and require the performer to explain the disagreed-with record.

In general, records can be organized as a form. A form can record all the information related to a particular step or series of steps in a workflow. The form can record the information related to a SOP. A workflow can have a sequential series of forms associated with the workflow. For example, a gene expression profiling workflow can include forms for recording information related to the homogenization of a tissue sample, to preparation of total RNA, to preparation of cRNA, and to preparation of hybridization mix.

A user can create a form when beginning the portion of workflow corresponding to the form. As the user proceeds through the series of steps in the workflow, he or she enters the relevant information in the form.

Information recorded in a form can include, for example, the name of the user performing the work, sample identity, sample type, reagent identity, reagent amount (e.g., as a weight or volume), reagent manufacturer and lot number, reagent expiration date, dates and times that operations were performed (e.g., as a single time, as a start and end time, or a start time and a duration), equipment used (e.g., as an equipment manufacturer, model, and serial number; or as an equipment identification number), results of measurements, identity and location of processed samples, or user comments. Other types of information not listed above can be included in the form to be recorded.

Entries to the form can be free-form (e.g., free text entered by the user), constrained to certain data types (e.g., numeric, date, or time), or constrained to choices provided in a picklist. For example, a comment entry can be a free text entry; a reagent quantity can be a number entry; and a equipment identity entry can be a constrained entry selected from a picklist. Reagent identity and equipment identity, in particular, can be constrained to choices from a picklist. The choices available in a picklist can be altered by selected users (e.g., users with permission to alter picklists, such as a system administrator). Alternatively, the picklist can be generated dynamically based on integration to an equipment inventory database or reagent inventory database.

At various points in completing the form, information is committed. Committing information can create an entry in an audit trail, for example, by recording all the information associated with the form along with metadata associated with the form, such as, for example, user identity and a date-and-time stamp. The audit trail can be used to reconstruct the addition, deletion, or modification of information associated with the form at a later time. The audit trail information can be stored at a remote location (e.g., on a server remote from a user's workstation). If information entered in the form is edited subsequent to a committing action, the committed information (and associated metadata) is retained for auditing purposes, such that the audit trail reveals the information that was initially entered as well as the edited information.

When the user completes the portion of workflow corresponding to the form, the user can submit the form for witnessing. Submitting a form for witnessing can close the form to further edits. A witnessor may determine that information in the form is incorrect. To correct the information, the form can be reopened for modifications. The system can require any modifications to the form be annotated by the user. Furthermore, modifications do not overwrite the information initially recorded, as required by the need for a complete audit trail.

Submitting a form for witnessing so can alert potential witnessors (i.e., other users with permission to witness forms) that a form is ready for witnessing. The system and method prevent a user from witnessing a form that he or she created or modified, ensuring that the witness is not a person who worked on the form. A witnessor can then review the form for accuracy and compliance with SOPs. In particular, a witnessor can be required to agree or disagree with selected entries in a form. If the witnessor believes that an entry is incorrect, incomplete, or requires revision, (i.e., the witnessor disagrees with the entry), the witnessor can so indicate, for example by adding a comment, and return the form to the user who submitted the form for witnessing. Preferably, the witnessor is prevented from modifying the entries in the form generated by the user. In other words, the witnessor cannot alter the primary data recorded by the user. The user then modifies the form (for example, by correcting information, adding comments, or the like) and once again submits the form for witnessing. The system generates an audit trail of the modifications, such that changes to records do not obscure previously recorded information. The witnessor reviews the resubmitted form, agreeing or disagreeing with entries as appropriate. The submit-review-modify procedure can be repeated as necessary. Once the witnessor agrees with all entries, the witnessor can witness the form. Once the form is witnessed, it can be closed to further additions, deletions or changes.

Users of the system can have varying levels of access to functions of the system. For example, some users can be witnessors and have greater privileges than other users. Users can be assigned to one of the following security levels: witnessor (full access), performer (decreased access), user (view only access), or inactive. Additional levels of access can be provided as necessary.

In some embodiments, the system can be configured to interlink with other electronic records and information systems to facilitate laboratory operations. For example, the system can interlink with other LIMS systems and data sets, to allow multivariate data analysis and trending across data types. The system can interlink with reagent tracking systems to validate use. For example, the system can dynamically generate a reagent picklist from a reagent database, alert users when a reagent has expired, track the use and quantity of reagent remaining, and remind users when additional reagent should be ordered. The system can track equipment use and maintenance, or interlink with equipment tracking systems to validate use. For example, the equipment tracking system can maintain records of when equipment was calibrated, tested, or serviced, and remind users when such activities are due. The system can interlink with training records (e.g., ISOTrain, training documentation) to validate user acceptability. For example, the system can check training records to determine whether or not a particular user has been trained to perform a particular workflow. If the user does not have the requisite training, the system can prevent the user from accessing related functions. The system can interlink with an electronic document system, to provide a user with an on-screen view of an experimental protocol (e.g., an SOP) describing the workflow being performed.

In some embodiments, the system can be used to facilitate laboratory management. For example, examination of date/time stamps can highlight inefficiencies in workflows, and thus guide evolution of workflows to improve efficiency. The system can identify resource needs to support specific programs and pipeline. For example, sample inventory calculation can be compared to processing metrics to evaluate efficiency of reagent use. The system can also be used in costing and budgeting: time-based roll ups of throughput across program, subprogram, study, experiment, end user, etc., can help review budget performance and estimate future budget needs. Reviewing trends across multiple experiments can help to identify potential ‘bad lots’ of reagents, miscalibrated equipment, or other sources of systematic experimental errors.

In some embodiments, the system can link to laboratory instrumentation. The system can use the links to generate worklists and capture electronic data. In one example, the system is linked to a barcode reader which is used to identify barcoded samples and automatically capture barcode information. For example, the system can implement an Affymetrix GeneChip operating system (GCOS) download of a minimal information about a microarray experiment (MIAME)-compliant worklists and data. The system can link to laboratory robotics systems to download worklists and capture specific actions performed by robots (e.g. volumes dispensed, incubation times). Linked to instrument systems (such as, for example, a spectrophotometer or thermal cycler) the system can download worklists or capture data for pass/fail checks and calculations. The system can allow flexible creation of worklists, where samples are chosen by a user, rather than by the system.

The system can interface with other software tools, including (but not limited to) Affymetrix GCOS, Spotfire Decision Site, NWA, Business Objects, Watson LIMS, and LabWare LIMS.

The various techniques, methods, and aspects described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer may include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link may include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software may be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (HTTP)). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

### EXAMPLE

The system and method described in the Example is configured to record, store and maintain records generated in the course of gene expression profiling experiments. In general, the experiments are carried out according to a set of standard operating procedures (SOPs).

In order to organize records, the records can be categorized according to a hierarchical scheme. The hierarchy can include one, two, three, four, or more than four levels. The levels of hierarchy (from highest to lowest) can be referred to as program, subprogram, study, and experiment. A program, for example, can encompass experiments related to discovery and development of a particular drug or drug candidate, or of drugs targeted to a particular disease, pathology, receptor, enzyme, or the like. A subprogram can be a subcategory of program, for example, including experiments involving a particular drug candidate within a program. The next level, study, can include those experiments in a subprogram designed to address a particular question. For example, a study can include experiments intended to evaluate the effects of a drug candidate on a particular organ. The experiment level includes records of particular laboratory actions. A single experiment can, in turn, include a series of steps (i.e., the workflow), that result in the desired experimental data or results being generated. The steps, or workflow, can be performed according to SOPs, as discussed above.

The system and method are configured to classify experiments into a category of study: for example, a research study, a preclinical study, a clinical study, or a product development study. A study will typically include a number of samples from, for example, subjects treated with different conditions. The system and method can record and maintain records of multiple concurrent studies.

1. User Login

A user begins a session by logging in, entering a username and password. Authentication of the entered username and password is done via LDAP Novell authentication. The user can use the same username and password combination used to log an institution-wide system (e.g., corporate- or university-wide system). After a successful login, the application stores the username in a cookie and will display it in the username field the next time the user displays the login page on the same machine. The cookie is stored per user per machine.

Fields
Username: Text Entry—Required. This field allows the user to enter the username. This field is case sensitive.
Password: Text Entry—Required. This field allows the user to enter the corresponding system password. This field is case sensitive.

Actions
Login: This button initiates login functionality. The following validations are done in this order:
   1. Username is null. The message states: Username is required.
   2. Password is null. The message states: Password is required.
   3. The user is not in the system or is Inactive or is not assigned one of the following roles (Witnessor, Performer, User). The message states: You do not have access to the system.
   4. The username and password combination does not validate against LDAP. The message states: The username and password do not match.

If the user fails the validation, a pop up box with the appropriate message appears. There is an OK button on the message. Clicking the OK button returns the user to the login page. If the user passes the validation the application brings the user to the Home Page/Portal page.
Logout: Users can manually logout out of the system. The system can automatically logout users after a specified period of inactivity, for example, 60 minutes.

2. Home Page

The Home Page, or Portal, is the main page for accessing all the functionality of the system. The Portal accesses the following subsequent sections:

Viewing and editing Studies

Creating, viewing and editing Experiments

Creating forms

Editing existing forms

Witnessing forms

Viewing Witnessed forms

The Portal is sub-divided by the various sections shown on the home page from left to right; top to bottom. The following table lists the sections and their actions and the roles that can access each. Validation of a user's role(s) and the link being clicked is done upon click of the link. The resulting page is listed in the View/Permissions column. “All the Open Forms” Select button also bases validation on the status of the form being opened.

| | | | |
|---|---|---|---|
| Section | Action | Role | View/Permissions |

Studies

| | | |
|---|---|---|
| View | All users | Read-only view |
| Edit | User | Read-only view |
| Edit | Performer, Witnessor | Edit view |
| Create Experiment | All active users | Create view |

Experiments

| | | |
|---|---|---|
| View | All users | Read-only view |
| Edit | User | Read-only view |
| Edit | Performer, Witnessor | Edit view |
| Create | All active users | Create view (user is assigned “role” |
| | | of “Lead Scientist” for future filtering |
| | | reasons only.) |

All the Open Forms

| | | |
|---|---|---|
| Select | open for | Any Performer can edit any form prior to initial submitting for |
| | entry | witnessing. |
| | (ENT) | Witnessors cannot not edit the form. Read-only view. |
| Select | ready for | Any Witnessor can witness a form. Once any section has been |
| | witnessing | witnessed and saved as such to the system, no one other |
| | (RYW) | than that person can witness the rest of the form. |
| | | Performers on a form cannot witness that same form. No |
| | | editing can be done. Read-only view. |
| Select | reopen for | Any Performer who was not the witnessor on that form can edit |
| | modifications | the form. |
| | (MOD) | Witnessors cannot not edit the form. Read-only view. |
| Select | resubmit | Only the listed Witnessor can rewitness the form. No editing |
| | for | can be done. All other Witnessors have read-only view. |
| | witnessing | Performers-No editing can be done. Read-only view. |
| | (RSW) | |
| Select | witnessed | The form is locked and cannot be edited nor have the status |
| | (WIT) | changed. Read-only view. |

Forms to be Witnessed

| | | |
|---|---|---|
| Witness | User, Performer | Read-only view |
| Witness | Witnessor (not on | Read-only view |
| | form) | |
| Witness | Witnessor (on form) | Witness view |

Witnessed Forms

| | | |
|---|---|---|
| View | All users | Read-only view |

The “Studies” section of the home page is a List box, in which each entry is a concatenation of the study id, an underscore (₁₃ ) and the study type (PREC, CLIN, RSCH, PDEV). The list of studies is based on which filtering link is selected. By default, this list is of Active studies. One and only one study can be selected at one time. This list is in alphabetical order, case insensitive.

Actions available in the “Studies” section are presented as the following links appearing above the field, labeled on the left as “Show:” and listed below the section label. Only one link can be selected at a time. The selected link shows without an underline:
Active—Refilters to show all the active studies in the list box. By default Active is selected.
Inactive—Refilters to show all the inactive studies in the list box

The following buttons appear below the listbox:
View—Migrates the user to the View Study interface based on the study highlighted.
Edit—Migrates the user to the Edit Study interface based on the study highlighted.
Create Experiment—Migrates the user to the Create Experiment interface based on the study highlighted.

At the time any one of the above buttons is pressed, validation is done to verify that there is a selected entry in the list box. If there is not, an appropriate message in pop-up format appears with an OK button. Clicking the OK button returns the user to the home page so that a selection can be made.

“Experiments” is the next section on the portal and appears as a list box to the right of the Studies section. The list displays the Protocol Title. The list of experiments is based on which filtering link is selected. By default, this list is of Active experiments (protocol title). One and only one protocol title can be selected at one time. This list is in alphabetical order, case insensitive.

A dropdown menu appears, “Available Forms:” appears below the listbox, and lists all the types of forms that can be created. This list is in the following order:

Homogenization

TotalRNA

cRNA

Hybridization

The following action links appear above the Experiments listbox, are labeled on the left as “Show:” and listed below the section label. Only one link can be selected at a time. The selected link shows without an underline:
Active—Refilters to show all the active studies in the list box. By default Active is selected.
Inactive—Refilters to show all the inactive studies in the list box

The following buttons appear below the listbox:
View—Migrates the user to the View Experiment interface based on the experiment highlighted.
Edit—Migrates the user to the Edit Experiment interface based on the study experiment highlighted.

At the time any one of the above buttons is pressed, validation is performed to verify that there is a selected entry in the list box. If there is not, an appropriate message in pop-up format appears with an OK button. Clicking the OK button returns the user to the home page so that a selection can be made.

The button labeled “Create” appears to the right of the Available Forms dropdown. Clicking the “Create” button migrates the user to an edit interface for a new form based on the study associated to the experiment highlighted and the form type selected. At the time Create is clicked, validation is done to verify the following in the listed order:
there is an experiment selected in the listbox. If there is not, an appropriate message in popup format appears with an OK button. Clicking the OK button returns the user to the home page so that a selection can be made.
there is a form type selected from the dropdown. If there is not, an appropriate message in popup format appears with an OK button. Clicking the OK button returns the user to the home page so that a selection can be made.

The forms filter (labeled “All the Open Forms”) is the next section on the portal and shows to the right of experiments. Each selection or deselection within the first 4 dropdowns associated with this section refreshes the Forms dropdown based on an “AND” statement. Null dropdown selections are ignored.

All fields default to no selection or <null> unless otherwise defined. The following fields will be shown:
Lead Scientist: Dropdown; (Lastname, Firstname).This is a list of all Lead Scientists in the database. Lead Scientists are the users who have created forms. This list is in alphabetical order, case insensitive.
Performers: Dropdown; (Lastname, Firstname). This is a list of all Performers in the database. Performers are the users who have already edited forms. This list is in alphabetical order, case insensitive.
Reviewer: Dropdown; (Lastname, Firstname). This is a list of all Reviewers in the database. Reviewers are the users who have witnessed forms. This list is in alphabetical order, case insensitive.
Status: Dropdown. This is a list of all the statuses that apply to forms. This list is in the following order:
   Open for Entry
   Ready For Witness
   Reopen for Modifications
   Resubmitted For Witness
   Witnessed
Forms: Dropdown; Required. This is a list of all the unique names for all available forms in the database. This list is based on the 4 filter dropdowns.

This list is in alphabetical order, case insensitive. If there are no forms that match the filter options the list will be empty.

A button labeled “Select” appears below the fields listed above in the forms filter section. Clicking the Select button migrates the user to the appropriate Form interface based on the filter results, the user's permission(s)/role(s) and the form's status. At the time the above button is pressed, validation is done to verify that there is a selected entry in the Forms dropdown box. If there is not, an appropriate message in pop-up format appears with an OK button. Clicking the OK button returns the user to the home page so that a selection can be made.

The fourth section on the portal, “Forms to be Witnessed,” shows below Studies and on the far left of the second row of sections. All fields default to no selection or <null> unless otherwise defined. The following fields are shown:
Forms to be Witnessed: List box; Required. This is a list of all the unique names for all available forms in the database with a status=(Ready for Witness, Resubmitted for Witness). One and only one study can be selected at a time. This list is in alphabetical order, case insensitive.

A button labeled “Witness” appears below the listbox. Clicking the Witness button migrates the user to the Witness interface based on the form highlighted. At the time the button is pressed, validation is done to verify that there is a selected entry in the list box. If there is not, an appropriate message in pop-up format appears with an OK button. Clicking the OK button returns the user to the home page so that a selection can be made.

The next section, “Witnessed Forms,” on the portal shows below Experiments and to the right of Forms to be Witnessed. The following fields are shown:
Witnessed Forms: List box; Required. This is a list of all the unique names for all available forms in the database with a status of (Witnessed). One and only one study can be selected at one time. This list is in alphabetical order, case insensitive.

The button labeled “View” appears below the listbox. Clicking the View button migrates the user to the Witness interface in View-only mode based on the form highlighted. At the time the button is pressed, validation is done to verify that there is a selected entry in the list box. If there is not, an appropriate message in pop-up format appears with an OK button. Clicking the OK button returns the user to the home page so that a selection can be made.

3. Sample Selection

When a new form is created, the user must associate samples to the form. In other words, the user records which samples will be worked up and recorded on the form. The samples are to be associated are selected from the sample inventory.

The interface described below is used to associate samples to a form. The same interface is used for all forms. The main page initially displays a list of samples that are available based on the study and the type of form selected by the user on the Portal page (and reflected in the label for this list) and a blank list for selected samples that will be on the resulting form. The page also displays dropdowns for filtering the list of available samples and a dropdown and radio buttons for sorting the list of selected samples in the resulting form.

Only one type of Sample is associated to each form. The only exception to this is the Homogenization form where both Animal Tissue and Animal Cells can be selected.

Specifically, in each form, users are prevented from selecting sample types other than those listed in the table below.

| | | Sample Type |
|---|---|---|
| Form ID | Form | Filter |
| HOMOGENIZATION | Homogenization of animal | Animal |
| | cells/tissues for RNA Extraction | Tissue or |
| | | Animal Cells |
| TOTALRNA | Total RNA Isolation Using Qiagen | Homogenate |
| | Mini and Midi Columns | |
| CRNA | Affymetrix cDNA & Biotin | Total RNA |
| | Labeled cRNA Synthesis | |
| HYBRIDIZATION | Fragmentation, Hybridization, | cRNA |
| | Staining, Washing & Scanning of | |
| | Affymetrix GeneChip Arrays | |

The following fields will be shown in the Sample Selection view:
List of Samples for Study <study name>: This multi-select picklist has the study name embedded in the label. This list contains all of the available and active samples that can be added to a form based on the AND statement formed by the values selected in the 6 filter dropdowns. When the page is initially displayed, the list of samples is filtered based only on the form type being created and the samples that are associated to the study as selected on the Portal page. Only samples associated to the study and applicable to the form being created are displayed. There is no functionality for a user to add additional samples that are not initially displayed. The samples are displayed in alphabetical order.
Selected Samples: This multi-select picklist is blank when the page is first displayed. Samples are added to the list from the “List of Samples for Study . . . ” list. The list of samples is sorted in the order that they are added.
Sort By: Sort By consists of 2 parts: a dropdown stating the order type and below that 2 radio buttons indicating direction.
   Dropdown—Required: This list is blank when the page is first displayed. Selecting a value from this list will re-sort the list of selected samples in the resulting form based on the value selected. It does not resort the samples on this page. Possible choices are:
      <Blank>
      Tissue Type
      Dose
      Drug Name
      Timepoint
      Route
      Group Name
      Subject ID
   Radio button—(“Asc”, “Desc”) Required: Specifies if the “Sort By” selected should be applied in Ascending (Asc) or Descending (Desc) alphabetical order, case insensitive. The default direction is Ascending.

The below “Filter Samples by:” dropdowns act as actions. Each selection or deselection of these 5 dropdowns automatically refreshes the “List of Samples for Study . . . ” dropdown based on an “AND” statement. Null dropdown selections are ignored in the statement. Selecting or deselecting a value in a dropdown has no effect on the list of selected samples but selecting a sample from the “List . . . ” picklist will prevent that entry from coming back to the filtered or unfiltered “List . . . ” picklist. All fields default to no selection or <null>unless otherwise defined. The following fields will be shown as labeled in “” with the field label above the field.
Tissue Type: Dropdown contains a list of all active Tissue Types. The list is in order by: orderedby (desc), alphabetically (asc).
Dose: Dropdown contains a distinct list of all dose values for the active samples associated with the selected study. The list is in alphabetical order.
Drug Name: Dropdown contains a list of all active Drug Names. The list is in order by: orderedby (desc), alphabetically (asc).
Timepoint: Dropdown contains a distinct list of all timepoint values for the active samples associated with the selected study. The list is in alphabetical order.
Route: Dropdown displays the list of all active Routes. The list is in order by: orderedby (desc), alphabetically (asc).
Group Name: Dropdown contains a distinct list of all Group name values for the active samples associated with the selected study. The list is in alphabetical order.

Two buttons, labeled “>>” and “All >>” appear top to bottom between the “List . . . ” picklist and the “Selected Samples” picklist. These buttons are used to move samples from one list to another. Clicking the “>>” button will move any highlighted samples from the “List . . . ” picklist to the “Selected Samples” picklist. Clicking the “All >>” button will move all available samples from the “List . . . ” picklist to the “Selected Samples” picklist.

Two additional buttons, “<<” and “All <<” will move any highlighted samples, or all samples, respectively, from the “Selected Samples” picklist to the “List . . . ” picklist when clicked.

A “Submit” button appears at the bottom of the page. Clicking submit commits the selections to the database, creates the form and takes the user to the main edit page of the created form based on the samples selected and the order defined.

The next five sections (Form Header, Equipment Selection, Reagent Selection, Commenting, and Form Witnessing) describe functionality available on all form types.

4. Form Header

Each instance of a form includes a header with identifying information for that instance. The header is read-only and cannot be edited. The following fields are in the Header.
Title: The Title is centered at the top of the Header section. It is specific to each form and specified in the view for each form (see below).
SOP No.: The QA approved number for the SOP that corresponds to the specific form.
Form No.: The current approved number of the Homogenization form.
Form ID: A number that uniquely identifies an instance of a form.
Start Date: The date (dd-Mon-yyyy) that the form was created. Internally the application will store the date and time.
Lead Scientist: The name of the person who created the form. This is always only one person. This is formatted “Firstname Lastname”
Reviewed By: Lists the name of the user who witnessed the form. This is always only one person. This is formatted “Firstname Lastname”.
Performed By: Distinct list of the names of each user who has edited this form. This could have more than one name. This is formatted “Firstname Lastname”. If more than one person, it is separated with a “, ” and the list is in alphabetical order by lastname, firstname.
SOP Version: The current approved version of the SOP that corresponds to the specific form.
Form Version: The current approved version of the specific form.

Form Status: Displays the current status of the form. Valid values are listed in the table below.

| Form Status | Description |
|---|---|
| Open for Entry | This is the initial state when a form is first |
| | created. It remains in this state until it is |
| | submitted for witnessing. |
| Ready For Witness | A form moves to this state after it has been |
| | submitted for witnessing. It remains in this |
| | state until witnessing has been completed or |
| | it is reopened for modifications. |
| Reopen for Modifications | Indicates that a witnessor has comments |
| | regarding the form and it has been sent back |
| | to the person(s) who completed the form. It |
| | will remain in this state until it is |
| | resubmitted to complete the witnessing |
| | process. |
| Resubmitted For Witness | This state indicates that additional |
| | modifications have been completed and the |
| | form has been sent back to the witnessor to |
| | complete the witnessing process. |
| Witnessed | This is the final state that a form moves to |
| | once the witnessing process has been |
| | completed. |

End Date: The date (dd-Mon-yyyy) that the form was initially submitted for witnessing. This value is only set once. It is not overwritten if a form goes through several iterations of the witnessing process. Internally the application will store the date and time.

5. Equipment Selection

Each of the various forms has a section for a user to record the equipment used in performing lab operations. The Equipment section allows the user to associate which equipment will be used to complete the particular process or indicate what equipment will not be used. The form is initially displayed with a default list of equipment types. This list represents the normal list of equipment that is required to complete the process. Although the types are prepopulated, the user must still specify which specific piece of equipment was used.

The default equipment types for each form (and section) vary are specified in the view specification for that form and section. Some forms have multiple equipment type sections. These values are set as a value in the SECTIONDEFAULTS table. Values are preset prior to deployment and can only be added or edited by a dba for Release 1.

If default equipment is not used, comments must be provided as to why. Additional equipment can also be added. The equipment should be displayed sorted by Equipment Type alphabetically.

The following fields appear in the Equipment Selection view.
Equipment Type: Read-only. Prepopulated from either the default list of equipment or from the new equipment being added.
Equipment ID: Dropdown—Required, if no comment supplied (checked when submit for witnessing initiated). Dropdown of all active equipment IDs, listed in alphabetical order, associated with the listed equipment type. After an equipment ID is selected, the application verifies that this Equipment type and equipment ID combination do not already exist in the table. If it does exist, an appropriate red error message appears on the top of the page and the selected value is deselected. If it does not exist, the Manufacturer and Model Number are refreshed with the associated data.
Manufacturer: Read-only. This is the manufacturer of the selected Equipment Type and equipment ID combination and updates automatically when a equipment ID is selected or deselected.
Model Number: Read-only. This is the model number of the selected Equipment Type and equipment ID combination and updates automatically when a equipment ID is selected or deselected.
Comments: Read-Only—Required only if no equipment ID was selected (checked when submit for witnessing initiated).

Three links are available from the Equipment selection view.
Edit Comment—Comments are editable by clicking on the Edit Comment link.
Delete—Clicking this link will remove the equipment from the table.
Submit—Commits the form data to the database and returns user to main form page. If any verification fails, an appropriate error message will appear at the top of the page in red.

The program home page has a link to an “Add more Equipment” section, which allows the user to add equipment which will be used to complete the particular process but is not part of the default equipment list or add the same type of equipment as one of the default equipment. The following fields appear in the “Add More Equipment” section.
Equipment Type: Dropdown—Required to Add. Dropdown of all active Equipment Types listed in alphabetical order. Selecting or deselecting an Equipment Type refreshes the Equipment ID list and clears any listed Manufacturer and Model Number.
Equipment ID: Dropdown—Required to Add. Dropdown of all active Equipment IDs, listed in alphabetical order, associated with the selected Equipment Type. The list is refreshed each time an Equipment Type is selected or deselected. After a Equipment ID is selected, the application will retrieve and display in read-only format the Manufacturer and Model Number from the database. It then verifies that this Equipment Type and Equipment ID do not already exist in the table. If it does exist, an appropriate red error message appears on the top of the page and the selected value is deselected.
Manufacturer: Read-only. This is the manufacturer of the selected Equipment Type and Equipment ID combination and updates automatically when either an Equipment Type or Equipment ID is selected or deselected.
Model Number: Read-only. This is the model number of the selected Equipment Type and Equipment ID combination and updates automatically when either an Equipment Type or Equipment ID is selected or deselected.
Add—Clicking “Add” adds the selected equipment to the table above if it is a valid, unique combination. The following verifications are done upon clicking the button:
   If a valid Equipment Type is not selected, a pop up appears stating that Equipment Type is required. An OK button is available. Clicking the OK button closes the popup and returns the user to the form.
   If a valid Equipment ID is not selected, a pop up appears stating that Equipment ID is required. An OK button is available. Clicking the OK button closes the popup and returns the user to the form.

6. Reagent Selection

Much like the Sample Selection and Equipment Selection views, Reagent Selection allows the user to associate which reagents will be used to complete the particular process. The form is initially displayed with a default list of reagent types. This list represents the normal list of reagents that are required to complete the process. Although the types are prepopulated, the user must still specify which specific reagent container was used. The default reagent types for each form (and section) are specified in the view specification for that form and section. If a default reagent is not used, comments must be provided as to why. Additional reagents can also be added. The reagents are displayed sorted by Reagent Type alphabetically. The following fields are shown in the Reagent Selection view.
Reagent Type: Read-only. Prepopulated from either the default list of reagents or from the new reagent being added.
Manufacturer—Lot Number: Dropdown—Required, if no comment supplied (checked when submit for witnessing initiated).Dropdown of all active Manufacturers, with active associated Lot Numbers concatenated by a hyphen, listed in alphabetical order, associated with the listed reagent type. This list will only contain items that have an Expiration date>Today. After an entry is selected, the application verifies that this Reagent type and Manufacturer-Lot Number combination do not already exist in the table. If it does exist, an appropriate red error message appears on the top of the page and the selected value is nulled. If it does not exist, the Expiration date is refreshed with the associated data.
Expiration Date: Read-only. Expiration date of the selected Reagent Type, Manufacturer-Lot Number.
Comments: Read-Only—Required if no Manufacturer-Lot Number was selected (checked when submit for witnessing initiated).

Three links is are available:
Edit Comment—Comments are editable by clicking on the Edit Comment link.
Delete—Clicking this link will remove the reagent from the table.
Submit—Commits the form data to the database and returns user to main form page. If any verification fails, an appropriate error message will appear at the top of the page in red.

The program home page has a link to an “Add More Reagents” section, which allows the user to add reagents which will be used to complete the particular process but is not part of the default reagent list or add the same type of reagent as one of the default reagents. The following fields appear in the “Add More Reagents” section.
Reagent Type: Dropdown—Required to Add. This dropdown is populated from table REAGENTTYPE and is a list of all active DESCRIPTION in order by ORDEREDBY (desc), DESCRIPTION (ascending, case sensitive).

Selecting a Reagent Type refreshes the Manufacturer-Lot Number list and clears any listed Expiration Date.
Manufacturer—Lot Number: Dropdown—Required to Add. Dropdown of all active Manufacturers, with active associated Lot Numbers concatenated by a hyphen, listed in alphabetical order, associated with the listed reagent type. This list will only contain items that have an Expiration date>Today. After an entry is selected, the application verifies that this Reagent type and Manufacturer-Lot Number combination do not already exist in the table. If it does exist, an appropriate red error message appears on the top of the page.
Expiration Date: Read-only. This is the expiration date of the Reagent Type and Manufacturer-Lot Number that was selected and updates automatically when either a Reagent Type or Manufacturer-Lot Number is selected or deselected.
Add—Adds the selected reagent to the table above if it is a valid, unique combination. The following verifications are done upon clicking the button:
   If a valid Reagent Type and Manufacturer-Lot is not selected, a pop-up box appears stating that a Manufacturer-Lot is required. An OK button is available. Clicking the OK button returns the user to the form.
   If a valid Manufacturer-Lot is not selected, a message appears at the top of the page stating that a Manufacturer-Lot is required. An OK button is available. Clicking the OK button returns the user to the form.

7. Commenting

When a user selects an “Edit Comment” button, a Commenting window appears. The Commenting window is split into two sections. The top section displays all historical comments and is in read-only mode. Historical comments are those comments that were from a previous change of form state. For example if a form is rejected during witnessing, when the form is re-opened for editing, all previously entered comments are displayed in the history section. Each comment block starts with the date it was entered and the author's username (network id), displayed in the format “DD-MON-YYYY/username”. The bottom section allows for entering in a new comment and editing the current session's comment.

Two actions are available in the Commenting window:
Submit—Updates the comment displayed in the main form page and closes the comment window.
Cancel—Discards all data additions or changes and returns the user to the main form page.

8. Form Witnessing

When a user has complete a form and submitted it for witnessing, all users with a witnessor role receive a message, e.g., an email, informing them that a form is ready for witnessing. A witnessor can select forms to witness from the program main page (in the “Forms to be Witnessed” section). Selecting forms for witnessing takes the witnessor to a Form Witnessing view, described below.

The Form Witnessing main page displays the entire form in a read-only mode. The page is broken into multiple sections. The specific sections are form dependent and are described below. There are no editable fields on the initial page. All data available is read-only. Four actions are available on the Form Witnessing main page:
Witness—Each section of the form has a Witness button, with the exception of Header. Clicking it will display the witness form for that section. See below for subsequent functionality.
Save for Later—Takes the user back to the home page. No data is lost and the form can be recalled and witnessing can be completed later.
Reopen for Modifications—The following verifications are made:
   the witnessor must complete any agreed/disagreed section/row
   the witnessor must provide a comment for a disagreed section/row
If the business rule fails, an appropriate error message is displayed and the form status is not changed. If the business rule passes, the form is unlocked for editing. An email is sent to all active users with a valid email address stored in the system, whose name is listed in the “performed by” and “lead scientist” sections of the header, notifying them that the form did not pass witnessing. The status of the form is set to “Reopen for Modifications” (MOD).
Witnessing Complete—All business rules related to the witnessing of sections/rows are checked. Business rules for each form are listed in the respective view spec. The following verifications are also made:
   the witnessor must complete any agreed section/row
   the witnessor must only agree on the form
If any one of the business rules fails, an appropriate error message is displayed and the form status is not changed. If the business rules all pass and the witnessor agreed with all content on the form, the form is marked as witnessing complete. An email is sent to all active users with a valid email address stored in the system, whose name is listed in the “performed by” and “lead scientist” sections of the header, notifying them that the form has been witnessed. The status of the form is set to “Witnessed” (WIT).

A PDF rendition of the form can be generated and stored in a central data storage system.

When the Witnessor selects the Witness action from the Witnessing Forms main page, the form is redisplayed in a Witnessing view. The specific fields that require witnessing are detailed below, in the description of the forms. On some forms, witnessors will be witnessing an entire row of data, multiple rows of data or whole sections at one time. In each case the process is the same. The witnessor must either agree or disagree with the content being witnessed. If Disagree is selected, “Witness Comments” must be entered. Witness comments should explain why the witnessor disagrees with the information recorded on the form.

For each item in the form that requires witnessing, two fields are displayed:
Witness: Radio Buttons—(“Agree”, “Disagree”) Required.Indicates whether the witnessor agrees or disagrees with the content for this row/section.
Witness Comments: Read-Only—Required, if witnessor disagreed with associated value (checked when submit as Witnessed.)

The following link is found in sections with multiple rows (samples, equipment, reagents):
Filldown—clicking this link enables the witnessor to Agree/Disagree with all rows in that section at once. Whatever is selected (or not selected) in the first row will be selected/deselected in all rows.

The following link is found on the right side of the form next to the “Witness Comments” label/field:
Edit Comment—Witness Comments are editable by clicking on the Edit Comment link.

The following button is found at the bottom of the page below all the rows of samples:
Submit—Commits the form data to the database and returns user to read-only main form page.

When a witnessor has chosen “Reopen for Modifications” for a particular form, performers who have worked on the form can access the form through the Witnessing Forms view. The main page displays the entire form in a read-only mode. There are no editable fields on the initial page. All data available is read-only. Performers have the following actions available:
Edit—Each section has an Edit button, with the exception of Header. Clicking it will display the edit form for that section. See below for subsequent functionality.
Save for Later—Takes the user back to the home page. No data is lost and the form can be recalled and witnessing can be completed later.
Resubmit for Witnessing—This button is found at the bottom of the form. The following verifications are done:
   All business rules related to the data entered on the form are checked.
   Any row/section whose Edit button was clicked (no matter if data was changed or not) and Submitted now requires a comment.
If any one of the business rules fails, an appropriate error message is displayed in red on the page and the form is not submitted for witnessing.
After validating the business rules, all blank fields on the form will have their values set to ‘N/A’ or some equivalent in the database. For example —999998 may be stored for number fields, but ‘N/A’ will be displayed in the browser. The form is no longer editable. An email is sent to the user who is the form's “Witnessor”, notifying the user that the form is ready to be re-witnessed. The status of the form is set to “Resubmit for Witnessing” (RSW).

When a section's edit button is clicked, there now appears all read-only fields for that section per the applicable form/section view spec. Once a row has had the Edit button clicked, it is now open for editing. Once open for editing and submitted, this row will stay open for editing for any and all performers until the status of the form is changed.
Edit—Each unopened row and/or section now has an Edit button. Clicking it will display the editable form for that associated row/section only. Clicking this edit button will also reset any witnessor's Agree/Disagree setting to null forcing the row to be rewitnessed. Any row/section whose Edit button was clicked now requires a comment if the witnessor had set the Witness value to Agree. Comment verification will be done on Resubmit for Witnessing. Even if the section does not have any row level witnessing/editing, there will still be a second level Edit button if the section has been witnessed as Agree. It will not be there if it was witnessed as Disagree.
Submit—Commits the edited data to the database and returns user to read-only main form page.

9. Homogenization Form

As described above, the workflow for a gene expression profiling experiment includes homogenization of a biological sample (e.g., a tissue sample or cell sample), preparation of total RNA from the homogenate, preparation of cRNA from the total RNA, and hybridization to a DNA array (e.g., a GENECHIP).

The homogenization form has been designed to record information in accord with a SOP for homogenization. The correspondence between the SOP and the form helps to ensure that homogenizations are performed in accord with the SOP, which in turns helps to ensure that experiments are reproducible.

The homogenization form interface opens with a summary of the content for each of the sections of the form. The data on this screen is displayed in read-only format. Each section of the form, unless otherwise noted, contains an edit button. Clicking on the edit button takes the user to another page where data can be edited for that section.

The main page displays the entire form in a read-only mode. The page is broken into multiple sections. The sections are: Header, Sample Identification, Equipment, Reagents, Reagent Preparation and Comments. All of the sections, with the exception of Header, have an associated edit button. Clicking the button will display a form to edit that section.

Three actions are available on the main page:
Edit: Each section, with the exception of Header, has an Edit button. Clicking this button will display an editable form for that section. Each section's editable form is described later in this document.
Save for Later: This button is found at the bottom of the form. Clicking this button takes the user back to the main page of the application.
Submit for Witnessing: This button is found at the bottom of the form.

Clicking this button locks the contents of the form and marks it as ready to be witnessed. The form is no longer editable. All business rules related to the data entered on the form are checked. If any one of the business rules fails, an appropriate error message is displayed in red on the page and the form is not submitted for witnessing. After validating the business rules, all blank fields on the form will have their values set to ‘N/A’ or some equivalent in the database. For example—999998 may be stored for number fields, but ‘N/A’ will be displayed in the browser. An email is sent to all active users who have the role of “Witnessor” associated to them, notifying them that the form is ready to be witnessed. The status of the form is set to “Ready for Witness” (RYW).

The Header contains pre-populated, non-editable information regarding the particular instance of the form. There is no editable form for the header.

Sample Identification provides a mechanism to enter information regarding the tissue or cells being homogenized and the homogenate that is being produced. The samples displayed were selected from the “Sample Selection” screen. By default, until a Protocol Selection is selected, the default sections, columns and fields for Animal Cells selected protocol are available pending an actual selection and submission.

The Sample Identification page requires the user to select a protocol to use for homogenization. The protocol chosen depends on the type of sample to be homogenized, animal tissue or animal cells. If animal tissue is selected then the user is required to select either fibrous or non-fibrous.

The following table shows which sections and columns are visible depending on which protocol selection is selected.

Protocol
Selection

| | | | |
|---|---|---|---|
| Section | | Animal | Animal |
| label | Column label | tissue | cells |

| | | |
|---|---|---|
| Sample | X | X |

| | | |
|---|---|---|
| Remove | X | X |
| Name/Freezer/LIMS ID | X | X |
| Nickname | X | X |
| Barcode | X | X |

| | |
|---|---|
| Homogenization Time | X |

| | |
|---|---|
| Tissue weight (mg) | X |
| Number of Pulses | X |
| Pulse Length | X |

| | |
|---|---|
| Geno Grinder | X |

| | |
|---|---|
| Rate | X |
| Time (sec.) | X |
| Number of Grinds | X |

| | | |
|---|---|---|
| Homogenate | X | X |

| | | |
|---|---|---|
| Number of Cells (10⁶) | | X |
| Vol of RLT Buffer + β (μL) | X | X |
| Name/Freezer | X | X |
| Barcode | X | X |

| | | |
|---|---|---|
| Comments | X | X |

Upon submitting for witnessing, all data in the hidden columns will be set to “N/A”.

The following values are recorded once for the entire section.

Sample
Remove: This optional checkbox indicates if the sample should be removed from the experiment. Removed samples will be identified with a red “X” on the view only page. Comments are required for the sample if this box is checked and are checked when the form is submitted for witnessing. Removing the sample does not delete it from the sample Inventory. It will remain associated to the form. Unchecking the box will reactivate the sample back to the form and all required fields must once again be provided before the form can be witnessed. When the form is submitted for witnessing any sample that has been removed will have all of its user editable attributes, with the exception of Comments, set to ‘N/A’.
Name: This read-only field is pre-populated with the selected Sample Name from the database.
Freezer: This read-only field is pre-populated with the Sample freezer name and below that the section and box location. This is the freezer specified in the Sample inventory. It is displayed below the sample's Name.
LIMS ID: This read-only field is pre-populated with the LIMS ID from the Sample Inventory. It is displayed below the Freezer information.
Nickname: This text box requires a unique entry (checked when the form is saved). The Nickname value is initially blank. The user can click on the “Autofill” link (below the column heading) to populate all of the rows with a system generated nickname. The system generated nickname consists of the nickname value from the table associated with the logged-in user and a sequential number appended to the end starting at 1. Nicknames must be unique across the entire form for non-removed samples. This field is editable before the barcode is reconciled.
Barcode: An integer value is required in this text box (checked when submit for witnessing initiated). In read-only format, this field shows the barcode of the sample being homogenized. When the section is clicked to edit for the first time, the field shows as null. Only the Remove, Nickname and Comments field are editable before the barcode is reconciled. The user must reconcile the barcode for a sample before additional information can be entered for that sample (e.g., by scanning the barcode on the sample container, which causes the system to compare the scanned barcode to the code associated with the sample name in the database). The barcode is reconciled against the database as soon as a value is entered and the barcode field loses “focus”. Once the barcode has been reconciled as valid, it is displayed in read-only mode. If the barcode does not reconcile, a pop up message appears with a note stating “Entered BARCODE <n> is not valid.” with an OK button. Clicking the OK button closes the popup and clears the field resetting focus back to the barcode field. This field is for verification and view only.

Homogenization Time
Tissue Weight (mg): Text box—Required (checked when submit for witnessing initiated). This is the weight of each Tissue being Homogenized. Only positive whole or decimal numbers greater than zero can be entered.
Number of Pulses: Text box—Not Required. This is the number of pulses that were required for Homogenization. Only positive whole numbers greater than zero can be entered.
Pulse Length: Text box—Not Required. This is the length of each Homogenization pulse. Only positive whole numbers greater than zero can be entered.

Geno Grinder

The Geno Grinder section is only displayed if Animal Tissue has been selected as the Protocol. In all cases, blank cells will be set to ‘N/A’.
Rate: Text box—not required. Rate (RPMs) that the Geno Grinder was set to. Only positive whole numbers greater than zero can be entered.
Time (sec.): Text box—not required. The time of each Geno Grinder grind. Only whole numbers can be entered.
Number of Grinds: Text box—not required. The number of times the Geno Grinder is used on a tissue. Only positive whole numbers greater than zero can be entered.

Homogenate
Number of Cells: Text box—required if animal cells protocol selected (checked when submit for witnessing initiated). This is the number of cells being homogenized. Only positive whole or decimal numbers greater than zero can be entered.
Vol of RLT+β(μL): Text box—required (checked when submit for witnessing initiated). Volume of RLT Buffer+β added to each sample. Only positive whole or decimal numbers greater than zero can be entered. This field is auto-calculated based on the type of protocol selected (Animal Tissue/non-fibrous, Animal Tissue/fibrous or Animal Cell). Although the system will calculate this value, the user has the option to change it. Any user-entered entry will be written over without warning by the system if the user changes the Tissue Weight (animal tissue) or Number of Cells (animal cells) field value. (Comments can be required if entry does not equal calculated value.)
   Animal Tissue
   1. Non-Fibrous Tissue: volume=20×“Tissue Weight” (rounded to 1 decimal)
   2. Fibrous Tissue: volume=10×“Tissue Weight” (rounded to 1 decimal)
   Animal Cells
   1. If the “Number of Cells” is less than 5×10⁶, then the Volume is 350 μL.
   2. If the “Number of Cells” is greater than or=to 5×10⁶, then the Volume is 600 μL.
Name: This read-only field is prepopulated with the system-generated Homogenate Name. The name is generated at the time that the form was created.
Freezer: The freezer entry includes a required dropdown and a required text box (checked when submit for witnessing initiated). This is the location that the Homogenate will be stored once it is produced. The freezer location is made up of two values. The first part is the freezer dropdown. The dropdown contains all of the active freezers as well as the value “Proceed to Next Step” in alphabetical order. The second part is a Text box field where the user enters the rack and box location within the specified freezer. Clicking on the “Filldown” link will set the freezer and the rack and box location for each row equal to the values specified in the first row for all samples that have not been removed and which have a valid barcode reconciled. If no value is specified in the first row, no action is taken. Any existing values will be overwritten with the value from the first row.
Barcode: A required textbox holding the barcode of the Homogenate being produced. The user must supply this value. Barcode must be unique across the entire form for non-removed samples.

Comments

Comments are displayed in read-only mode on the screen and are editable by clicking on the edit comment link. A comment is required if the Remove checkbox was selected (checked when submit for witnessing initiated).

A “submit” link is provided at the bottom of the sample identification page. Clicking this link commits the form data to the database and returns user to main form page. The following verifications are done at this time:
Nickname is required.
Nickname is unique.
Homogenate Barcode is unique.
Verify Freezer Section/Box does not exceed 40 characters.

If any verification fails, an appropriate error message will appear on the page in red. The user is required to make corrections to these fields if any of the verifications fails.

Reagent preparation is done according to an SOP. Quantities of reagents to be used are calculated by the system, using formulas from the SOP. Fields in the reagent preparation section are:
Prepare RLT buffer+β-Mercaptoethanol: Read-only note
Add <n> μL β-Mercaptoethanol to <x> mL RLT buffer. Read-only; calculated. <x> is calculated based on the total amount of all “Vol of RLT+β” (each rounded to 1 decimal) added for all of the samples in the Sample Identification section plus 2 mL. <n> is calculated by multiplying <x> times 10. For example, if the total amount of “Vol RLT+β” is 40 mL, <x> would be 42 mL. The <n> value would then be 420. These values are recalculated every time the Sample Identification section is saved.
Lysate Digestion table—This table is visible for only Animal Tissue-Fibrous samples. Otherwise the values are hidden and ignored.Read-Only—Table is recalculated every time it is displayed in both read-only or edit mode. This read-only table contains four columns left to right: “Nickname”, “Vol of RLT+β (μL)”, “Vol of H₂O (μL)” and “Vol of Proteinase K (μL) ”. There is a row for every sample listed in the Sample Identification section as well as one row of totals of all associated calculated fields with the label “Total” in the Nickname column. All Samples are listed, even those that have been removed. All fields automatically update and recalculate when associated Sample Identification data is changed. The first and second columns are the associated values in the Sample Identification section for the corresponding Sample. Each “Vol of RLT+β (μL)” is rounded to 1 decimal. The third column is calculated using the following formula:
   (Vol of RLT+β)*2
The fourth column is calculated using the following formula:
   (Vol of H₂O)+(Vol of RLT+β)*0.1
Proteinase K digestion incubation time
   Start/Stop: Text boxes—Both are required if Animal Tissue and Fibrous Tissue selected (checked when submit for witnessing initiated). Start and stop times for the Proteinase K digestion. Four numbers must be entered for each value. Time is to be entered as HHMM in military time. HH must be <=23. MM must be <=59.
Comments: Comments are displayed in read-only mode on the screen and are editable by clicking on the Edit Comment link.

The following button is found at the bottom of the screen below the “Edit Comment” link:
Submit: Commits the form data to the database and returns user to main form page. The following verifications are done at this time:
   Start Time must be valid
   Stop Time must be valid

Where valid=
HHMM must be four whole numbers only.
HH must be <=23.
MM must be <=59.

If any verification fails, an appropriate error message will appear on the page in red.

The Equipment section of the homogenization form allows the user to associate which equipment was used to complete the Homogenization process. The default equipment types that are listed alphabetically in this section are: Balance, Biological Safety Cabinet, Centrifuge, Geno Grinder, Pipet (listed 4 times), Rotor-stator Homogenizer, and Waterbath.

The Reagent section of the homogenization form allows the user to associate which reagents will be used to complete the Homogenization process. The default reagent types that are listed alphabetically in this section are: β-Mercaptoethanol, Proteinase K, QIAShredder Kit, RLT Buffer, RNase/DNase-free water, Sterile 70% Ethanol.

The fields that are required to be witnessed are described below, broken down by section of the homogenization form.

Header: There are no fields that require witnessing in the header.

Sample Identification: Every row in the Sample Identification table requires witnessing.

Equipment: Every row in the Equipment table requires witnessing.

Reagent: Every row in the Reagent table requires witnessing.

Reagent Preparation: The “Proteinase K digestion incubation time (Start and Stop)” and the Comments (if any were supplied) must be witnessed. There is one witnessing Agree/Disagree section to cover both of these items.

Comments: If a comment was supplied, it must be witnessed.

10. Total RNA Form

The interface opens with a summary of the content for each of the sections of the form. The data on this screen is displayed in read-only format. Each section of the form, unless otherwise noted, contains an edit button. Clicking on the edit button takes the user to another page where data can be edited for that section.

The main page displays the entire form in a read-only mode. The page is broken into multiple sections. The sections are: Header, Sample Identification, RNA Isolation (Equipment, Reagents and Elution subsections), Total RNA Quantitation By UV Spectrophotometry, RNA Precipitation (Equipment, Reagents and Precipitate subsections), Total RNA Quantitation By UV Spectrophotometry (re-precipitates) and Comments. All of the sections, with the exception of Header, have an associated edit button. Clicking the button will display a form to edit that section.

The following actions are available on the Total RNA form main page.
Edit: Each section, with the exception of Header, has an Edit button. Clicking this button will display an editable form for that section. Each section's editable form is described later in this document.
Save for Later: This button is found at the bottom of the form. Clicking this button takes the user back to the main page of the application.
Submit for Witnessing: This button is found at the bottom of the form. Clicking this button locks the contents of the form and marks it as ready to be witnessed. The form is no longer editable. All business rules related to the data entered on the form are checked. If any one of the business rules fails, an appropriate error message is displayed in red on the page and the form is not submitted for witnessing. After validating the business rules, all blank fields on the form will have their values set to ‘N/A’ or some equivalent in the database. For example—999998 may be stored for number fields, but ‘N/A’ will be displayed in the browser. An email is sent to all active users, who have the role of “Witnessor” associated to them, notifying them that the form is ready to be witnessed. The status of the form is set to “Ready to Witnessing” (RYW).

The Header contains pre-populated, non-editable information regarding the particular instance of the form. There is no editable form for the header. The specific title for this form is “Total RNA Isolation Using Qiagen Mini and Midi Columns”.

The Sample Identification section provides a mechanism to enter information regarding the homogenate and the Total RNA that is being prepared from it. The samples displayed were selected from the “Sample Selection” screen.

Fields available in the Sample Identification section are:
Protocol Selection: A required radio button for selecting RNA preparation by either Qiagen Mini or Midi protocol (checked when submit for witnessing initiated).
Tissue Type: A required radio button for selecting Fibrous Tissue, Non-Fibrous Tissue, or Animal Cells as appropriate for the source of the homogenate (checked when submit for witnessing initiated).

The following fields are recorded once for each sample.
Homogenate
   Remove: An optional checkbox to indicate if the sample should be removed from the experiment. Removed samples will be identified with a red “X” on the view only page. Comments are required for the sample if this box is checked and are checked when the form is submitted for witnessing. Removing the sample does not delete it from the sample Inventory. It will remain associated to the form. Unchecking the box will reactivate the sample back to the form and all required fields must once again be provided before the form can be witnessed. When the form is submitted for witnessing any sample that has been removed will have all of its user editable attributes, with the exception of Comments, set to “N/A”.
   Name: This read-only field is prepopulated with the selected Sample Name(s) from the database.
   Freezer: This read-only field is prepopulated with the Sample freezer name and below that the rack and box. This is the freezer specified in the Sample inventory. It is displayed below the sample's Name.
   LIMS ID: This read-only field is prepopulated with the LIMS ID from the Sample Inventory. It is displayed below the Freezer information.
   Nickname: A required text box (checked when the form is saved). The Nickname value is initially blank. The user can click on the “Autofill” link (below the column heading) to populate all of the rows with a system generated nickname. The system generated nickname consists of the nickname value from the User table associated with the logged-in user and a sequential number appended to the end starting at 1. Nicknames must be unique across the entire form for non-removed samples. This field is editable before the barcode is reconciled. This value must be unique across this form.
   Barcode: A required text box (checked when submit for witnessing initiated). In read-only format, this field shows the barcode of the sample being Homogenized. When the section is clicked to edit for the first time, the field shows as null. Only the Remove, Nickname and Comments field are editable before the barcode is reconciled. The user must reconcile the barcode for a sample before additional information can be entered for that sample. The barcode is reconciled against the database as soon as a value is entered and the barcode field loses “focus”. Once the barcode has been reconciled as valid, it is displayed in read-only mode. If the barcode does not reconcile, a pop up message appears with a note stating “Entered BARCODE <n> is not valid.” with an OK button. Clicking the OK button closes the popup and clears the field resetting focus back to the barcode field. Barcode can be read in via barcode reader.
   Lysate Volume: A required text box (checked when submit for witnessing initiated). Whole or decimal numbers can be entered. Records the volume of lysate used.
   Additional columns needed for calculations pertaining to fibrous tissue samples can be included.
Total RNA
   Name: This read-only field is prepopulated with the system generated Total RNA Name. The name is generated at the time that the form is created.
   Freezer: This is the location that the Total RNA will be stored once it is produced. The freezer location is made up of two values. The first part is the freezer dropdown. The dropdown contains all of the active freezers as well as the value “Proceed to Next Step” in alphabetical order. The second part is a Text Box field where the user enters the rack and box location within the specified freezer. Clicking on the “Filldown” link will set the freezer and the rack and box location for each row equal to the values specified in the first row for all samples that have not been removed and which have a nickname designated. If no value is specified in the first row, no action is taken. Any existing values will be overwritten with the value from the first row. Both the dropdown and text box are required (checked when submit for witnessing initiated).
   Barcode: The barcode of the Total RNA being produced is entered in this required text box. The user must supply this value. Whole numbers only. Barcode can be read in via barcode reader. Barcode must be unique across the entire form for non-removed samples.
Comments: Comments are displayed in read-only mode on the screen and are editable by clicking on the Edit Comment link.

A “Submit” button is found at the bottom of the page below all the rows of samples. Clicking “Submit” commits the form data to the database and returns user to main form page. The following verifications are done at this time:
Nickname is required.
Nickname is unique.
Total RNA Barcode is unique.
Verify Freezer Section/Box does not exceed 40 characters.

If any verification fails, an appropriate error message will appear on the page in red.

The RNA Isolation section is subdivided into three subsections, each with its own fields and actions. The three subsections are Equipment, Reagents and Elution. Each is described below.

The RNA Isolation/Equipment subsection allows the user to associate which equipment was used to complete the RNA isolation process. The default equipment types that are listed alphabetically in this section are: Microcentrifuge, Pipet (listed 4 times), Spectrophotometer, Tabletop Centrifuge.

The RNA Isolation/Reagents subsection allows the user to associate which reagents will be used to complete the RNA isolation process. The default reagent types that are listed alphabetically in this section are: 100% Ethanol, 1×TE (pH 8.0), Qiagen RNeasy Kit, RNase/DNase-free water, Sterile 70% Ethanol.

The RNA Isolation/Elution subsection allows a user to record Elution volumes and start and end times for standing. The fields provided in this subsection are:
1^{st} Elution: Volume: <x> μL: <x>—Text Box—Required (checked when submit for witnessing initiated). Whole or decimal numbers can be entered.
Begin Stand: Text Box—Required (checked when submit for witnessing initiated). 4 whole numbers must be entered. Represents military time in the format HHMM. HH is <=23. MM is <=59.
End Stand: Text Box—Required (checked when submit for witnessing initiated). 4 whole numbers must be entered. Represents military time in the format HHMM. HH is <=23. MM is <=59.
2^{nd} Elution: Begin Stand: Text Box—Required (checked when submit for witnessing initiated). 4 whole numbers must be entered. Represents military time in the format HHMM. HH is <=23. MM is <=59.
End Stand: Text Box—Required (checked when submit for witnessing initiated). 4 whole numbers must be entered. Represents military time in the format HHMM. HH is <=23. MM is <=59.
Comments: Comments are displayed in read-only mode on the screen and are editable by clicking on the Edit Comment link.

At the bottom of the RNA Isolation/Elution view is a Submit button. Clicking Submit commits the form data to the database and returns user to main form page. The following verifications are done at this time:
Begin stand values must be valid
End stand values must be valid
Where valid=
   HHMM must be four whole numbers only.
   HH must be <=23.
   MM must be <=59.

If any verification fails, an appropriate error message will appear on the page in red.

In the Total RNA Quantitation By UV Spectrophotometry section, one row is automatically added to this section for each Sample in the Sample Identification section. This includes Samples that have been removed. For Samples that have been removed, the required field rules do not apply and all fields will be N/A'd out.

The following fields are recorded once for the entire section.
1. Dilute samples 1: <a> in 1×TE: <b> μL of Sample+<c> μL of 1×TE
   <a>—Text Box—Required (checked when submit for witnessing initiated) Whole or decimal numbers can be entered.
   <b>—Text Box—Required (checked when submit for witnessing initiated) Whole or decimal numbers can be entered.
   <C>—Text Box—Required (checked when submit for witnessing initiated) Whole or decimal numbers can be entered.
   2. Dilute samples1: <d> in RNase/DNase-free Water: <e> μL of Sample+<f> μL of RNase/DNase-free Water
   <d>—Text Box—Required (checked when submit for witnessing initiated) Whole or decimal numbers can be entered.
   <e>—Text Box—Required (checked when submit for witnessing initiated) Whole or decimal numbers can be entered.
   <f>—Text Box—Required (checked when submit for witnessing initiated) Whole or decimal numbers can be entered.

The following fields are recorded once for each Sample.
Nickname: Read-Only—This is the Nickname of the Sample copied from the Sample Identification section. If the Nickname is updated in Sample Identification, it is updated here.
A₂₆₀/A₂₈₀ (1×TE): Text Box—Required (checked when submit for witnessing initiated).Whole or decimal numbers can be entered. The value is rounded to 1 decimal precision.
Ratio P/F: dropdown—Required (checked when submit for witnessing initiated). Valid values are Pass or Fail. Value is automatically calculated after the user enters the A₂₆₀/A₂₈₀ ratio using the following formula:
   1. If the Ratio is less than or equal to 2.3 and greater than or equal to 1.9, the value is Pass.
   2. If the Ratio is less than 1.9 or greater than 2.3, the value is Fail
The calculated value is input in to the field but the user can override this calculated value with an input value. Clicking the “Filldown” will set the value for each row equal to the value in the first row. If no value is specified in the first row, no action is taken. Any existing values will be overwritten with the value from the first row.
A₂₆₀ (H₂O): Text Box—Required (checked when submit for witnessing initiated). Whole or decimal numbers can be entered. The value is rounded to 3 decimal precision.
Remaining Volume (μL): Text Box—Required (checked when submit for witnessing initiated). Whole or decimal numbers can be entered. The value is rounded to 1 decimal precision. Clicking the “Filldown” will set the Remaining volume value for each row equal to the value in the first row. If no value is specified in the first row, no action is taken. Any existing values will be overwritten with the value from the first row.
Dilution Factor (H₂O): Text Box—Required (checked when submit for witnessing initiated). Whole or decimal numbers can be entered. The value is rounded to 1 decimal precision.
RNA Conc. (μg/μL): Read-only The value is rounded to 3 decimal precision. Value is automatically calculated once the “A₂₆₀ (H₂O)” and “Dilution Factor (H₂O)” are entered. The equation is recalculated if any of the attributes in the equation change to a different valid value. The following formula is used:

$$RNA Conc ( µg \text{/} µL ) = \frac{( {A}_{260} ( {H}_{2} O ) \cdot 40 \cdot Dilution Factor ( {H}_{2} O ) )}{1000}$$
RNA Yield (μg): Read-only. The value is rounded to 1 decimal precision. Value is automatically calculated once the “RNA Conc. (μL)” Value is calculated and “Remaining Volume (μL)” is entered. The equation is recalculated if any of the attributes in the equation change to a different valid value. The following formula is used:
   RNA Yield(μL)=RNA Conc.(μg/μL)·remaining Volume(μL)
Target Conc. (μg/μL): Text Box—Required (checked when submit for witnessing initiated). Whole or decimal numbers can be entered. The value is rounded to 3 decimal precision. Clicking the “Filldown” will set the Target Concentration value for each row equal to the value in the first row. If no value is specified in the first row, no action is taken. Any existing values will be overwritten with the value from the first row.
Vol. Of Water Added to Normalize (μL): Read-only. The value is rounded to 1 decimal precision. Value is automatically calculated once the “RNA Conc. (μg/μL)” is calculated and the “Target Conc. (μg/μL)” and “Remaining Volume (μL)” are entered. The equation is recalculated if any of the attributes in the equation change to a different valid value. The following formula is used:

$$water to add ( µL ) = ( \frac{RNA Conc . ( µg \text{/} µL )}{Target Conc . ( µg \text{/} µL )} * Remaining Volume ( µL ) ) - Remaining Volume ( µL )$$

If “Vol. Of Water Added to Normalize (μL)” <0, then “Vol. Of Water Added to Normalize (μL)” is to be set to “N/A”.
Final Action: Dropdown—Required (checked when submit for witnessing initiated). Valid values are Pass, Fail, Re-PPT (Re-Precipitate) or Re-Pur (Re-Purify). Value is automatically calculated after the system calculates the “Vol. Of Water Added to Normalize (μL)” using the following rules:
   1. If the “Ratio P/F” value is Fail, the value is Re-Pur.
   2. If the “Ratio P/F” value is Pass and the “Vol. Of Water Added to Normalize (μL)” is greater than or equal to 0, the value is Pass.
   3. If the “Ratio P/F” value is Pass and the “Vol. Of Water Added to Normalize (μL)” is set to “N/A” because the calculation resulted in a volume<0, the value is Re-PPT.

Clicking the “Filldown” will set the Final Action value for each row equal to the value in the first row. If no value is specified in the first row, no action is taken. Any existing values will be overwritten with the value from the first row. Any calculated value can be written over with a keyed value.
Agilent P/F: Dropdown—optional (Pass, Fail, N/A). If no selection is made it will be updated to equal N/A.
Comments: Comments are displayed in read-only mode on the screen and are editable by clicking on the Edit Comment link.

At the bottom of the Total RNA Quantitation by Spectrophotometry view is a Submit button. Clicking Submit commits the form data to the database and returns user to main form page.

The RNA Precipitation section is actually broken into three subsections, each with its own fields. The three subsections are Equipment, Reagents and Precipitate. Each is described below.

The Equipment subsection allows the user to associate which equipment will be used to complete the RNA Precipitation process. The default equipment types that are listed alphabetically in this section are: Microcentrifuge, Pipet (listed 4 times), Spectrophotometer.

The Reagent subsection allows the user to associate which reagents will be used to complete the RNA Purification process. The default reagent types that are listed alphabetically in this section are: 100% Ethanol, 1×TE (ph 8.0), 80% Ethanol, 3M Sodium Acetate, Glycogen, RNase/DNase-free water.

In the Precipitate subsection, one row is automatically created for every sample that has a “Final Action” value of “Re-PPT” after quantitation (see above). If a Sample's “Final Action” value is set to “Re-PPT” and then later changed to either “Pass” or “Fail”, the Sample remains in this table, but the values are no longer required. The user, however, is required to enter Comments against that Sample.

The following fields in the Precipitate subsection are recorded once for each Sample.
Nickname: read-only—Automatically copied from the Sample Identification section for the Sample being re-precipitated.
Volume of Sample (μL) [x]: read-only—Automatically copied from the RNA Isolation section (“Remaining Volume”) column.
Volume of 100% Ethanol Added (μL) [2.5x]: Read-only—Automatically calculated based on the following formula:
   Volume of 100% Ethanol Added=2.5*Volume of Sample
Volume of 3M Sodium Acetate Added (μL) [0.5x]: Read-only—Automatically calculated based on the following formula:
   Volume of 3M Sodium Acetate Added=0.1*Volume of Sample
Resuspension Volume: Text Box—Required (checked when submit for witnessing initiated). This is the amount of RNase/DNase-free water that the pellet is resuspended in. Whole or decimal numbers are allowed.
Incubation Freezer: This is the location that the precipitate will incubated in. The freezer location is made up of two values. The first part is the freezer dropdown. The dropdown contains all of the active freezers as well as the value “Proceed to Next Step” in alphabetical order. The second part is a Text Box field where the user enters the rack and box location within the specified freezer. Both the dropdown and text box are required. Clicking on the “Filldown” link will set the freezer and the rack and box location for each row equal to the values specified in the first row for all samples that have not been removed. If no value is specified in the first row, no action is taken. Any existing values will be overwritten with the value from the first row. The picklist defaults to a blank value. The Text Box field defaults to a blank value.
Storage Freezer: This is the location that the precipitate will be stored in once it is produced. The freezer location is made up of two values. The first part is the freezer dropdown. The dropdown contains all of the active freezers as well as the value “Proceed to Next Step” in alphabetical order. The second part is a Text Box field where the user enters the rack and box location within the specified freezer. Both the dropdown and text box are required. Clicking on the “Filldown” link will set the freezer and the rack and box location for each row equal to the values specified in the first row for all samples that have not been removed. If no value is specified in the first row, no action is taken. Any existing values will be overwritten with the value from the first row. The picklist defaults to a blank value. The Text Box field defaults to a blank value.
Comments: Read-Only. This comment is meant to apply only to the sample it's associated with. A separate comments entry is available to apply to the entire form. Comments are displayed in read-only mode on the screen and are editable by clicking on the Edit Comment link.
“Incubation Start Time <a> and Date <b>:
   <a>=text box; Required (checked when submit for witnessing initiated); 4 whole numbers must be entered. Represents the start time in military format (HHMM).
   <b>=text box; Required (checked when submit for witnessing initiated); date incubation was started. Must be entered in DD-MMM-YYYY format.
End Time <c> and Date <d>:
   <c>=text box; Required (checked when submit for witnessing initiated); 4 whole numbers must be entered. Represents the end time in military format (HHMM).
   <d>=text box; Required (checked when submit for witnessing initiated); date incubation was stopped. Must be entered in DD-MMM-YYYY format.)

At the bottom of the Precipitation view is a Submit button. Clicking Submit commits the form data to the database and returns user to main form page.

In the next section, Re-precipitate Total RNA Quantitation by UV Spectrophotometry, one row is automatically created for every sample that has a “Final Action” value of “Re-PPT” in after Total RNA Quantitation. If a Sample's “Final Action” value is set to “Re-PPT” and then later changed to either “Pass” or “Fail”, the Sample remains in this table, but the values are no longer required. In this case, the user is required to enter a comment. The fields and actions for Re-precipitate Total RNA Quantitation are the same as for Total RNA Quantitation.

The final section appearing at the end of the Total RNA form is a comment section. As with other comments, the comments are displayed in read-only mode on the screen and are editable by clicking on the associated Edit Comment link. The following button is found at the bottom of the screen below the “Edit Comment” link: “Submit.” Clicking submit commits the form data to the database and returns user to main form page.

The following sections detail which fields/rows/sections require witnessing on the Total RNA form.

Header: There are no fields that require witnessing in the header.

Sample Identification: Each row in the Sample Identification table requires witnessing.

RNA Isolation:
Equipment: Every row in the table requires witnessing.
Reagent: Every row in the table requires witnessing.
Elution: 1 witness is required for the whole section. If comments have been supplied, they must also be witnessed. There is one witnessing Agree/Disagree section to cover this whole section.

Total RNA Quantitation By UV Spectrophotometry: All 1×TE and RNase/DNase-free water dilution fields must be witnessed. If supplied, the comments must be witnessed. There is one witnessing Agree/Disagree section to cover both of these items. Every row in the Quantitation table must be witnessed.

RNA Precipitation:
Equipment: Every row in the table requires witnessing.
Reagent: Every row in the table requires witnessing.
Precipitation: Every row in the Precipitation table must be witnessed.

Re-Precipitate Total RNA Quantitation By UV Spectrophotometry: All 1×TE and RNase/DNase-free water dilution fields must be witnessed. If supplied, the comments must be witnessed. There is one witnessing Agree/Disagree section to cover both of these items. Every row in the Quantitation table must be witnessed.

Comments: If a comment was supplied, it must be witnessed.

11. cRNA Form

Once the total RNA has been isolated from the homogenate, the RNA is reverse-transcribed to cDNA. The cDNA is purified and transcribed to afford biotinylated cRNA which can be used for hybridization to a DNA array. Records describing these steps are recorded on the cRNA form.

The main page of the cRNA form displays the entire form in a read-only mode. The page is broken into multiple sections. The sections are:

1. Header

2. Sample Identification

3. First and Second Strand cDNA Synthesis
a. Equipment
b. Reagents
c. Synthesis

4. cDNA Cleanup
a. Equipment
b. Reagents
c. Cleanup

5. Synthesis of Biotinylated cRNA
a. Equipment
b. Reagents
c. Synthesis

6. Biotin-Labeled cRNA Cleanup
a. Equipment
b. Reagents
c. Cleanup

7. cRNA Quantitation By UV Spectrophotometry
a. Equipment
b. Reagents
c. Concentration/Yield

8. cRNA Precipitation
a. Equipment
b. Reagents
c. Precipitation

9. Re-precipitate cRNA Quantitation By UV Spectrophotometry
a. Equipment
b. Reagents
c. Concentration/Yield

10. Comments

Three actions are available from the cRNA form main page. First, Each section has an Edit button. Clicking it will display an editable form for that section. Each section's editable form is described below. Second, there is a Save for Later action that takes the user back to the main page of the application. No data is lost and the form can be recalled and edited again later. Third, Submit for Witnessing locks the content of the form and marks it as ready to be witnessed. The form is no longer editable. All business rules related to the data entered on the form are checked. If any one of the business rules fails, an appropriate error message is displayed and the form is not submitted for witnessing. After validating the business rules, all blank fields on the form will have their values set to ‘N/A’ or some equivalent in the database. For example—999998 may be stored for number fields, but ‘N/A’ will be displayed in the browser. An email is sent to all active users, who have the role of “Witnessor” associated to them, notifying them that the form is ready to be witnessed. The status of the form is set to “Ready for Witness” (RYW).

1. Header

The Header contains pre-populated, non-editable information regarding the particular instance of the form. There is no editable form for the header. The title for this form is “Affymetrix cDNA & Biotin Labeled cRNA Synthesis”.

2. Sample Identification

Sample Identification provides a mechanism to enter information regarding the Total RNA and the cRNA that is being prepared from it. The samples displayed were selected from the “Sample Selection” screen described above.

The following fields are available in the Sample Identification section of the cRNA form.
Remove: Checkbox—optional. Indicates if Sample should be removed from the experiment. Checking the box should highlight the row. Comments are required for the Sample if this box is checked and are checked when the form is submitted for witnessing. Removing the Sample does not delete it from the Sample Inventory. It should remain associated to the form. Unchecking the box, will add the sample back to the form and all required fields must be provided before the form can be witnessed. When the form is submitted for witnessing any sample that has been removed will have all of its user editable attributes, with the exception of comments, set to ‘N/A’.
Total RNA:
   Name: Read-Only. This field is prepopulated with the Total RNA Name from the database.
   Freezer: Read-Only. This field is prepopulated with the Total RNA freezer location. This is the freezer specified in the Sample inventory. It is displayed below the LIMS ID.
   LIMS ID: Read-Only. This field is prepopulated with the LIMS ID from the Sample Inventory. It is displayed below the Total RNA Name. This is the LIMS ID of the Tissue or Cell Sample that the Total RNA originates from.
   Nickname: Text Entry—Required (checked when the form is saved). The Nickname value is initially blank. The user can click on the “Filldown” link to populate the rows with system generated Nicknames. The system generates Nickname by taking the Nickname value from the User table (for the logged-in user) and appending a sequential number to it starting at 1. Nicknames must be unique across the entire form for non-removed samples. This field is editable before the barcode is reconciled.
   Barcode: Text Entry—Required (checked when submit for witnessing initiated). Barcode of the Total RNA that the cRNA is being produced from. The user must reconcile the barcode for each Total RNA before entering additional information for the Sample. Only the Remove, Nickname and Comments field are editable before the barcode is reconciled with the barcode stored in the database. Once the barcode has been reconciled, it is displayed in read-only mode and cannot be changed. Barcodes can be entered via barcode readers.
   Total RNA Reference #: Text Entry—Required (checked when submit for witnessing initiated). Alphanumeric characters can be entered. This is typically either a Notebook reference number or a previously completed Form reference number (Form No. in Header).
   Total RNA Starting Quantity (μg): Text Entry—Required (checked when submit for witnessing initiated). Whole numbers or decimal numbers can be entered. 1 decimal precision.
cRNA:
   Name: Read-Only. This field is prepopulated with the system-generated cRNA Name. The name was generated when the form was created.
   Freezer: This is the location that the cRNA will be stored in once it is produced. The freezer location is made up of two values. The first part is the freezer dropdown. The dropdown contains all of the active freezers as well as the value “Proceed to Next Step” in alphabetical order. The second part is a text entry field where the user enters the rack and box location within the specified freezer. Clicking on the “Filldown” link will set the freezer and the rack and box location for each row equal to the values specified in the first row for all samples that have not been removed. If no value is specified in the first row, no action is taken. Any existing values will be overwritten with the value from the first row. The dropdown defaults to a blank value. The text entry field defaults to a blank value.
   Barcode: Text Entry—Required (checked when submit for witnessing initiated). Barcode of the cRNA being produced. The user must supply this value. Barcodes can be entered via barcode readers. Barcode must be unique across the entire form for non-removed samples.
Comments: Read-Only—Required if the Remove checkbox was selected. (checked when submit for witnessing initiated). Comments are displayed in read-only mode on the screen and are editable by clicking on the Edit Comment link.

A “Submit” button is found at the bottom of the page below all the rows of samples. Clicking submit commits the form data to the database and returns user to main form page. The following verifications are done at this time:
Nickname is required.
Nickname is unique.
cRNA Barcode is unique.
Verify Freezer Section/Box does not exceed 40 characters.

If any verification fails, an appropriate error message will appear on the page in red.

3. First and Second Strand cDNA Synthesis

The First and Second Strand cDNA Synthesis section is divided into three subsections, each with its own fields. The three subsections are Equipment, Reagents and Synthesis. Each is described below.

a. Equipment

This section allows the user to associate which equipment will be used to complete the First and Second Strand cDNA Synthesis process. The default equipment types that should be listed in this section are Microcentrifuge, Pipet (listed 4 times), Thermal Cycler.

b. Reagents

This section allows the user to associate which reagents will be used to complete the First and Second Strand cDNA Synthesis process. The default reagent types are 0.5M EDTA, GeneChip One-Cycle cDNA Synthesis Kit, GeneChip Poly-A RNA Control Dilution Buffer, GeneChip Poly-A RNA Control Working Stock, and RNase/DNase-free Water.

c. Synthesis

The Synthesis section is broken up into five steps, paralleling the experimental steps required in the cDNA synthesis. The section is a combination of read-only text notes and labels as well as read-only calculations and input values (each indicated by a <alpha/calc> entry in the text.)
1. Place on ice for at least 2 minutes following primer annealing incubation.
“Start Time:” <X> “End Time:” <Y>
   <X>=text-entry—Required (checked when submit for witnessing initiated). Time should be entered in military format (HHMM). 4 whole numbers only. HH must be <=23. MM must be <=59.
   <Y>=text-entry—Required (checked when submit for witnessing initiated). Time should be entered in military format (HHMM). 4 whole numbers only. HH must be <=23. MM must be <=59.

This section is read-only and contains precalculated amounts of each component to be used. The calculations are based on the numbers of samples (n) plus one. If a sample has been removed, it is still counted in the total number of samples. This section also lists the Total Volume for all of the components. The following table lists each component and the amount added per Sample.

2. Prepare First Strand Master Mix for n+1 reactions as follows:

| | Per Reaction | n + 1 Reactions |
|---|---|---|
| Component | (μL) | (μL) |
| 0.1M DTT | 2 | <n + 1 * 2> |
| 10 mM dNTP | 1 | <n + 1 * 1> |
| 5x First Strand Reaction Mix | 4 | <n + 1 * 4> |
| Total | 7 | <n + 1 * 7> |

3. Place on ice for at least 2 minutes following 1^{st} Strand cDNA Synthesis.
   “StartTime:” <a> “End Time:” <b>
   <a>=text-entry—Required (checked when submit for witnessing initiated) Time should be entered in military format (HHMM). 4 whole numbers only. HH must be <=23. MM must be <=59.
   <b>=text-entry—Required (checked when submit for witnessing initiated) Time should be entered in military format (HHMM). 4 whole numbers only. HH must be <=23. MM must be <=59.

This section is read-only and contains precalculated amounts of each component to be used. The calculations are based on the numbers of samples (n) plus one. If a Sample has been removed, it is still counted in the total number of samples. This section also lists the Total Volume for all of the components. The following table lists each component and the amount added per Sample.

4. Prepare Second Strand Master Mix for n+1 reactions as follows:

| | Per Reaction | n + 1 Reactions |
|---|---|---|
| Component | (μL) | (μL) |
| 5x Second Strand Reaction Mix | 30 | <n + 1 * 30> |
| 10 mM dNTP | 3 | <n + 1 * 3> |
| E. Coli DNA Ligase | 1 | <n + 1 * 1> |
| E. Coli DNA Polymerase I | 4 | <n + 1 * 4> |
| RNase H | 1 | <n + 1 * 1> |
| RNase/DNase-free Water | 91 | <n + 1 * 91> |
| Total | 130 | <n + 1 * 130> |

5. Proceed with cDNA clean-up or store at −70° C. following 2^{nd} strand cDNA synthesis:
   Freezer location: Dropdown—Optional. Defaults to “N/A” if value not supplied. Dropdown includes a list of all of the active freezers.
   Freezer Section Box: Text box—Optional, 40 chars (checked when submit form)

User enters rack and box information into text box. The same location is used for all samples. This is an optional value as the user may choose to continue on with the next step of the process and not store the Samples in the freezer.
Comments: Read-Only—Not required. Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
HHMM must be four whole numbers only.
HH must be <=23.
MM must be <=59.
Verify Freezer Section/Box does not exceed 40 characters.

If any verification fails, an appropriate error message will appear on the page in red.

4. cDNA Cleanup

The cDNA Cleanup section is subdivided into three subsections, each with its own fields. The three subsections are Equipment, Reagents and Cleanup. Each is described below.

a. Equipment

This section allows the user to associate which equipment will be used to complete the cDNA Cleanup process. The default equipment types that should be listed in this section are Microcentrifuge, Pipet (listed 4 times).

b. Reagents

This section allows the user to associate which reagents will be used to complete cDNA Cleanup process. The default reagent types are 100% Ethanol, 3M Sodium Acetate, GeneChip Sample Cleanup Module.

c. Cleanup
10μL 3M Sodium Acetate added: Yes/No: radio buttons—Required (checked when submit for witnessing initiated). Valid values are “Yes” or “No”
Elute and store the cDNA at −70° C.:
   Freezer location: Dropdown—Optional. Defaults to “N/A” if value not supplied. Dropdown includes a list of all of the active freezers.
   Freezer Section Box: Text box—Optional, 40 chars (checked when submit form)

User enters rack and box information into text box. The same location is used for all samples. This is an optional value as the user may choose to continue on with the next step of the process and not store the Samples in the freezer.
Comments: Read-Only—Required if the user selected “Yes” for the “10 μL 3M Sodium Acetate added” value. User should list which Samples the Sodium Acetate was added to. System only checks that a comment has been supplied.

The user is responsible for making sure it is the valid content. Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
If the user selected “Yes” for the “10μL 3M Sodium Acetate added” value, Comments are required.
Verify Freezer Section/Box does not exceed 40 characters.

If any verification fails, an appropriate error message will appear on the page in red.

5. Synthesis of Biotinylated cRNA

The Synthesis of Biotinylated cRNA section is subdivided into three subsections, each with its own fields. The three subsections are Equipment, Reagents and Synthesis. Each is described below.

a. Equipment

This section allows the user to associate which equipment will be used to complete the Synthesis of Biotinylated cRNA process. The default equipment types that should be listed in this section are Microcentrifuge, Pipet (listed 4 times), and Thermal Cycler.

b. Reagents

This section allows the user to associate which reagents will be used to complete the Synthesis of Biotinylated cRNA process. The default reagent types are 0.5M EDTA, GeneChip IVT Labeling Kit, and RNase/DNase-free Water.

c. Synthesis

Prepare IVT Master Mix for n+1 reactions as follows: This section is read-only and contains precalculated amounts of each component to be used. The calculations are based on the numbers of samples (n) plus one. If a Sample has been removed, it is still counted in the total number of samples. This section also lists the Total Volume for all of the components. The following table lists each component and the amount added per Sample.

| | Per Reaction | n + 1 Reactions |
|---|---|---|
| Component | (μL) | (μL) |
| 10X IVT Labeling Buffer | 4 | <n + 1 * 4> |
| IVT Labeling Enzyme Mix | 4 | <n + 1 * 4> |
| IVT Labeling NTP Mix | 12 | <n + 1 * 12> |
| RNase/DNase-free Water | 8 | <n + 1 * 8> |
| Total | 28 | <n + 1 * 28> |

Proceed with cRNA clean-up or store at −70° C.
   Freezer location: Dropdown—Required (checked when submit for witnessing initiated). The dropdown contains all of the active freezers as well as the value “Proceed to Next Step” in alphabetical order.
   Freezer Section Box: Text box—Required (checked when submit for witnessing initiated); 40 chars (checked when submit form)
Comments: Read-Only—Not required. Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
Verify Freezer Section/Box does not exceed 40 characters.

If any verification fails, an appropriate error message will appear on the page in red.

6. Biotin-Labeled cRNA Cleanup

The cDNA Cleanup section is subdivided into three subsections, each with its own fields. The three subsections are Equipment, Reagents and Cleanup. Each is described below.

a. Equipment

This section allows the user to associate which equipment will be used to complete the Biotin-Labeled cRNA Cleanup process. The default equipment types that should be listed in this section are Microcentrifuge, Pipet (listed 4 times).

b. Reagents

This section allows the user to associate which reagents will be used to complete Biotin-Labeled cRNA Cleanup process. The default reagent types are 80% Ethanol, 100% Ethanol, GeneChip Sample Cleanup Module, RNase/DNase-free Water.

c. Cleanup
Elute and store the biotin-labeled cRNA at −70° C. or proceed to cRNA quantitation.

At this point the user has the option of storing biotin-labeled cRNA at −70° C. and resuming the cRNA procedure at a later time. If the user chooses to store the eluted biotin-labeled cRNA at −70° C., the freezer location information should be recorded. If, instead, the user proceeds to cRNA quantiation, no freezer location needs to be recorded in this part of the form.
Freezer location: Dropdown—Required (checked when submit for witnessing initiated). The dropdown contains all of the active freezers as well as the value “Proceed to Next Step” in alphabetical order.
Freezer Section Box: Text entry—Required (checked when submit for witnessing initiated); 40 Characters (checked when submit form). User enters rack and box information into text box. The same location is used for all samples.
Comments: Read-Only—Not required. Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
Verify Freezer Section/Box does not exceed 40 characters.

If any verification fails, an appropriate error message will appear on the page in red.

7. cRNA Quantitation by UV Spectrophotometry

The cRNA Quantitation by UV Spectrophotometry section is subdivided into three subsections, each with its own fields. The three subsections are Equipment, Reagents and Concentration/Yield. Each is described below.

a. Equipment

This section allows the user to associate which equipment will be used to complete the cRNA Quantitation By UV Spectrophotometry process. The default equipment types listed in this section are Pipet (listed 4 times), Spectrophotometer.

b. Reagents

This section allows the user to associate which reagents will be used to complete the cRNA Quantitation By UV Spectrophotometry process. The default reagent types are 1×TE (pH 8.0), RNase/DNase free Water.

c. Concentration/Yield

One row is automatically added to this section for each sample in the Sample Identification section. This includes samples that have been removed. For samples that have been removed, the required field rules do not apply and all fields will be N/A'd out.

The following fields are recorded once for the entire section.
Dilute samples 1:<w> in 1×TE: <x> μL of sample+<y> μL of 1×TE
   <w>=text-entry—Required (checked when submit for witnessing initiated). Whole or decimal numbers can be entered.
   <x>=text-entry—Required (checked when submit for witnessing initiated). Whole or decimal numbers can be entered.
   <y>=text-entry—Required (checked when submit for witnessing initiated). Whole or decimal numbers can be entered.
2. Dilute samples 1:<a> in RNase/DNase-free Water: <bx> μL of Sample+<c> μL of RNase/DNase-free Water.
   <a>=text-entry—Required (checked when submit for witnessing initiated). Whole or decimal numbers can be entered.
   <b>=text-entry—Required (checked when submit for witnessing initiated). Whole or decimal numbers can be entered.
   <c>=text-entry—Required (checked when submit for witnessing initiated). Whole or decimal numbers can be entered.
Comments: Read-Only. General comments regarding the Dilution process.

Comments are displayed in read-only mode on the screen and are editable by clicking on the edit link.

The following fields are recorded once for each sample.
Nickname: Read-Only—This is the Nickname of the Sample copied from the Sample Identification section in the same order they are in Sample Identification.
A₂₆₀/A₂₈₀ (1×TE): text-entry—Required (checked when submit for witnessing initiated). Whole or decimal numbers can be entered. 1 decimal precision.
Ratio P/F: Dropdown—Required (checked when submit for witnessing initiated). Valid values are Pass or Fail. Value is automatically calculated after the user enters the A₂₆₀/A₂₈₀ ratio using the following rules:
   1. If the Ratio is less than or equal to 2.3 and greater than or equal to 1.9, the value is Pass.
   2. If the Ratio is less than 1.9 or greater than 2.3, the value is Fail.
A₂₆₀ (H₂O): text-entry—Required (checked when submit for witnessing initiated). Whole or decimal numbers can be entered. 3 decimal precision.
Remaining Volume (μL): text-entry—Required (checked when submit for witnessing initiated). Whole or decimal numbers can be entered. 1 decimal precision. Clicking the “Filldown” will set the Remaining volume value for each row equal to the value in the first row. If no value is specified in the first row, no action is taken. Any existing values will be overwritten with the value from the first row.
Dilution Factor (H₂O): text-entry—Required (checked when submit for witnessing initiated). Whole or decimal numbers can be entered. 1 decimal precision.
cRNA Conc. (μg/μL): Read-only. Value is automatically calculated once the “A₂₆₀” and “Dilution Factor” are entered. 3 decimal precision. The equation is recalculated if any of the attributes in the equation change value. The following formula is used:
   cRNA Conc.=(“A₂₆₀”*40*“Dilution Factor”) /1000
cRNA Yield (μg): Read-only. Value is automatically calculated once the “cRNA Conc.” value is calculated and “Remaining Volume” is entered. 1 decimal precision. The equation is recalculated if any of the attributes in the equation change value. The following formula is used:
   cRNA Yield=“cRNA Conc.”*“Remaining Volume”
Total RNA Starting Quantity (μg): Read-only. This value is copied from the Sample Identification section. 1 decimal precision. It is not editable by the user. If the value updates in the Sample Identification section, any calculated value, in this section, that uses “Total RNA Starting Quantity” should be automatically recalculated. For example “Adjusted cRNA Yield”.
Adjusted cRNA Yield (μg): Read-only. Value is automatically calculated once the “Total RNA Starting Quantity” is entered and the “cRNA Yield” value is calculated. 1 decimal precision. The equation is recalculated if any of the attributes in the equation change value. The following formula is used:
   Adjusted cRNA Yield=“cRNA Yield”−“Total RNA Starting Quantity”
Final cRNA Conc. (μg/μL): Read-only. Value is automatically calculated once the “Remaining Volume” is entered and the “Adjusted cRNA Yield” value is calculated. 3 decimal precision. The equation is recalculated if any of the attributes in the equation change value. The following formula is used:
   Final cRNA Conc.=“Adjusted cRNA Yield”/“Remaining Volume”
IVT Amp. (fold): Read-only. Value is automatically calculated once the “Total RNA Starting Quantity” is entered and the “Adjusted cRNA Yield” value is calculated. 1 decimal precision. The equation is recalculated if any of the attributes in the equation change value. The following formula is used:

$$IVT Amp . = \frac{“ Adjusted cRNA Yield ”}{“ Total RNA Starting Quantity ”}$$
Fold Amp. (P/F): Dropdown—Required (checked when submit for witnessing initiated). Valid values are Pass or Fail. Value is automatically calculated after the user enters the IVT Amplification using the following formula:
   1. If the IVT Amplification is greater than or equal to 3, the value is Pass.
   2. If the IVT Amplification is less than 3, the value is Fail.
Target Conc. (μg/μL): text-entry—Required (checked when submit for witnessing initiated). Whole or decimal numbers can be entered. 3 decimal precision. Clicking the “Filldown” will set the Target Concentration value for each row equal to the value in the first row. If no value is specified in the first row, no action is taken. Any existing values will be overwritten with the value from the first row.
Vol. Of H₂O Added to Normalize (μL): Read-only. Value is automatically calculated once the “Final cRNA Conc.” is calculated and the “Target Conc.” And “Remaining Volume” are entered. 1 decimal precision. The equation is recalculated if any of the attributes in the equation change value. The following formula is used:

$$water to add ( µL ) = ( \frac{final RNA Conc . ( µg \text{/} µL )}{Target Conc . ( µg \text{/} µL )} * Remaining Volume ( µL ) ) - Remaining Volume ( µL )$$
If “Vol. Of Water Added to Normalize (μL)”<0, then “Vol. Of Water Added to Normalize (μL)” is to be set to “N/A”.
Final Action: Dropdown—Required (checked when submit for witnessing initiated). Valid values are Pass, Fail or Re-PPT (Re-Precipitate). Value is automatically calculated after the system calculates the “Vol. Of Water Added to Normalize” and a value has been supplied for the “A_{260/}A₂₈₀ Ratio” and “Fold Amplification” using the following formula:
   1. If the “A₂₆₀/A₂₈₀ Ratio” value is Fail or the “Fold Amplification” is Fail the value is Fail.
   2. If the “A₂₆₀/A₂₈₀ Ratio” value is Pass and “Fold Amplification” is Pass and the “Vol. Of Water Added to Normalize” is greater than or equal to 0, the value is Pass.
   3. If the “A₂₆₀/A₂₈₀ Ratio” value is Pass and “Fold Amplification” is Pass and the “Vol. Of Water Added to Normalize” is set to N/A, the value is Re-PPT.
Clicking the “Filldown” will set the Final Action value for each row equal to the value in the first row. If no value is specified in the first row, no action is taken. Any existing values will be overwritten with the value from the first row.
Comments: Read-Only. Optional. Comments are displayed in read-only mode on the screen and are editable by clicking on the Edit Comment link.

A “Submit” button is found at the bottom of the page below all the rows of samples. Clicking Submit commits the form data to the database and returns user to main form page.

8. cRNA Precipitation

The cRNA Precipitation section is subdivided into three sub sections, each with its own fields. The three subsections are Equipment, Reagents and Precipitation. Each is described below.

a. Equipment

This section allows the user to associate which equipment will be used to complete the cRNA Precipitation process. The default equipment types listed in this section are Microcentrifuge, and Pipet (listed 4 times).

b. Reagents

This section allows the user to associate which reagents will be used to complete the cRNA Precipitation process. The default reagent types are 100% Ethanol, 1×TE (pH 8.0), 7.5M Ammonium Acetate, 80% Ethanol, Glycogen, and RNase/DNase-free Water.

c. Precipitation

One row is automatically created in this section for every sample that has a “Final Action” value of “Re-PPT” above. If a Sample's “Final Action” value is set to “Re-PPT” and then later changed to either “Pass” or “Fail”, the Sample remains in this table, but the values are no longer required. All values are set to ‘N/A’ when the form is submitted for witnessing.

The following fields are recorded once for each Sample.
Nickname: read-only—Automatically copied from the Sample Identification section for the Sample being re-precipitated.
Volume of Sample (μL) [x]: read-only—Automatically copied from the cRNA Quantitation By UV Spectrophotometry section (“Remaining Volume”) column.
Volume of 100% Ethanol Added (μL) [2.5x]: read-only—Automatically calculated based on the following formula:
   “Volume of 100% Ethanol Added”=2.5*“Volume of Sample”
Volume of 7.5M Ammonium Acetate Added (μL) [0.5x]: read-only—Automatically calculated based on the following formula:
   “Volume of 7.5M Ammonium Acetate Added”=0.5*“Volume of Sample”
Resuspension Volume (μL): text-entry—Required (checked when submit for witnessing initiated). This is the amount of RNase/DNase-free Water that the pellet is resuspended in. Whole or decimal numbers are allowed.
Incubation Freezer:
   Freezer location: Dropdown—required. The dropdown contains all of the active freezers as well as the value “Proceed to Next Step” in alphabetical order.
   Freezer Section Box: Text box—Required; 40 chars (checked when submit form). The same location is used for all samples. Clicking on the “Filldown” link will set the freezer and the rack and box location for each row equal to the values specified in the first row for all samples that have not been removed. If no value is specified in the first row, no action is taken. Any existing values will be overwritten with the value from the first row.
Storage Freezer:
   Freezer location: Dropdown—required. The dropdown contains all of the active freezers as well as the value “Proceed to Next Step” in alphabetical order.
   Freezer Section Box: Text box—Required; 40 chars (checked when submit form). The same location is used for all samples. Clicking on the “Filldown” link will set the freezer and the rack and box location for each row equal to the values specified in the first row for all samples that have not been removed. If no value is specified in the first row, no action is taken. Any existing values will be overwritten with the value from the first row.
Comments: Read-Only. Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
Verify Freezer Section/Box does not exceed 40 characters.

If any verification fails, an appropriate error message will appear on the page in red.

9. Re-precipitate cRNA Quantitation By UV Spectrophotometry

Fields for the Re-precipitate cRNA Quantitation by UV Spectrophotometry are as listed above for cRNA Quantitation by UV Spectrophotometry.

10. Comments

These are general comments that the user can enter that apply to the entire form.

The following sections detail which fields require witnessing on the this form. For details on the Witnessing Process see view spec “VS03 Form Witnessing”.
1. Header: There are no fields that require witnessing in the header.
2. Sample Identification: Every row in the Sample Identification table requires witnessing.
3. First and Second Strand cDNA Synthesis
   a. Equipment: Every row in the table requires witnessing.
   b. Reagent: Every row in the table requires witnessing.
   c. Synthesis: All ice start and end times must be witnessed. Freezer must be witnessed. If comments have been supplied, they must also be witnessed.

4. cDNA Cleanup
a. Equipment: Every row in the table requires witnessing.
b. Reagent: Every row in the table requires witnessing.
c. Synthesis: The “Sodium Acetate added: Yes/No” value must be witnessed. Freezer must be witnessed. If comments have been supplied, they must also be witnessed.

5. Synthesis of Biotinylated cRNA
a. Equipment: Every row in the table requires witnessing.
b. Reagents: Every row in the table requires witnessing.
c. Synthesis: Freezer must be witnessed. If comments have been supplied, they must also be witnessed.

6. Biotin-Labeled cRNA Cleanup
a. Equipment: Every row in the table requires witnessing.
b. Reagents: Every row in the table requires witnessing.
c. Cleanup: Freezer must be witnessed. If comments have been supplied, they must also be witnessed.

7. cRNA Quantitation By UV Spectrophotometry
a. Equipment: Every row in the table requires witnessing.
b. Reagents: Every row in the table requires witnessing.
c. Concentration/Yield: All 1×TE and RNase/DNase-free Water dilution fields must be witnessed. Freezer must be witnessed. If supplied, the comments must be witnessed. Every row in the Quantitation table must be witnessed.

8. cRNA Precipitation
a. Equipment: Every row in the table requires witnessing.
b. Reagent: Every row in the table requires witnessing.
c. Precipitation: Every row in the Precipitation table must be witnessed.

9. Re-precipitate cRNA Quantitation By UV Spectrophotometry
a. Equipment: Every row in the table requires witnessing.
b. Reagent: Every row in the table requires witnessing.
c. Concentration/Yield: All 1×TE and RNase/DNase-free Water dilution fields must be witnessed. Freezer must be witnessed. If supplied, the comments must be witnessed. Every row in the Quantitation table must be witnessed.

10. Comments: If a Comment was supplied, it must be witnessed.

12. Hybridization Form

Once the biotinylated cRNA has been prepared and purified, it can be hybridized to a DNA array, such as a GeneChip. The Hybridization form records details of this phase of a gene expression profiling experiment.

The main page displays the entire form in a read-only mode. The page is broken into multiple sections. The sections are:

1. Header

2. Sample Identification

3. Fragmentation of cRNA

4. Hybridize Fragmented cRNA to GeneChip

4. Washing and Staining of GeneChips

5. Comments

All of the sections, with the exception of Header, have an associated Edit button. Clicking the button will display a form to edit that section.

The following buttons are all active as indicated.
Edit: Each section, with the exception of Header, has an Edit button. Clicking this button will display an editable form for that section. Each section's editable form is described below.
Save for Later: This button is found at the bottom of the form. Clicking this button takes the user back to the main page of the application.
“Submit for Witnessing”—This button is found at the bottom of the form. Clicking this button locks the contents of the form and marks it as ready to be witnessed. The form is no longer editable. All business rules related to the data entered on the form are checked. If any one of the business rules fails, an appropriate error message is displayed in red on the page and the form is not submitted for witnessing. After validating the business rules, all blank fields on the form will have their values set to ‘N/A’ or some equivalent in the database. For example—999998 may be stored for number fields, but ‘N/A’ will be displayed in the browser. An email is sent to all active users, who have the role of “Witnessor” associated to them, notifying them that the form is ready to be witnessed. The status of the form is set to “Ready For Witness” (RYW).

1. Header

The Header contains pre-populated, non-editable information regarding the particular instance of the form. There is no editable form for the header. The title for this form is “Fragmentation, Hybridization, Staining, Washing & Scanning of Affymetrix GeneChip Arrays”.

2. Sample Identification

Sample Identification provides a mechanism to enter information regarding the cRNA and the GeneChip that is being prepared from it. The samples displayed were selected from the “Sample Selection” screen.

The following Sample Identification fields are recorded once for each sample.
Remove: Checkbox—optional. Indicates if the sample should be removed from the experiment. Removed samples will be identified with a red “X” on the view only page. Comments are required for the sample if this box is checked and are checked when the form is submitted for witnessing.

Removing the sample does not delete it from the sample Inventory. It will remain associated to the form. Unchecking the box will reactivate the sample back to the form and all required fields must once again be provided before the form can be witnessed. When the form is submitted for witnessing any sample that has been removed will have all of its user editable attributes, with the exception of Comments, set to ‘N/A’.
cRNA
   Name: Read-Only. This field is prepopulated with the cRNA Name from the database.
   Freezer: Read-Only. This field is prepopulated with the Sample freezer name and below that the section. This is the freezer specified in the Sample inventory. It is displayed below the sample's Name.
   LIMS ID: Read-Only. This field is prepopulated with the LIMS ID from the Sample Inventory. It is displayed below the Freezer information.
   Nickname: Text Entry—Required (checked when the form is saved);

Unique. The Nickname value is initially blank. The user can click on the “Filldown” link (below the column heading) to populate all of the rows with a system generated nickname. The system generated nickname consists of the nickname value from the User table associated with the logged in user and a sequential number appended to the end starting at 1. Nicknames must be unique across the entire form for non-removed samples. This field is editable before the barcode is reconciled.
Barcode: Text Entry—Required (checked when submit for witnessing initiated). In readonly format, this field shows the barcode of the cRNA from which the GeneChip is being produced. When the section is clicked to edit, the field shows as null. Only the Remove, Nickname and Comments field are editable before the barcode is reconciled. The user must reconcile the barcode for a sample before additional information can be entered for that sample. The barcode is reconciled against the database as soon as a value is entered and the barcode field loses “focus”. Once the barcode has been reconciled as valid, it is displayed in read-only mode. If the barcode does not reconcile, a pop up message appears with a note stating “Entered BARCODE <n> is not valid.” with an OK button. Clicking the OK button closes the popup and clears the field resetting focus back to the barcode field.
cRNA Reference #: Text Entry—Required (checked when submit for witnessing initiated). Alphanumeric characters can be entered. This is typically either a Notebook reference number or a previously completed Form reference number (Form No. in Header).
Hybmix
   Name: Read-Only. This field is prepopulated with the system generated Hybmix Name. The name is generated at the time that the form was created. The name is generated at the time that the form was created.
   Barcode: Text Entry—Required (checked when submit for witnessing initiated). Barcode of the Hybmix that is being produced. The user must supply this value. Barcode must be unique across the entire form for non-removed samples.
   Freezer: Dropdown—Required; alphabetical order (checked when submit for witnessing initiated). Text box—Required; 40 chars (checked when submit form). This is the location that the Hybmix will be stored once it is produced. The freezer location is made up of two values. The first part is the freezer dropdown. The dropdown contains all of the active freezers as well as the value “Proceed to Next Step” in alphabetical order. The second part is a text entry field where the user enters the rack and box location within the specified freezer. Clicking on the “Filldown” link will set the freezer and the rack and box location for each row equal to the values specified in the first row for all samples that have not been removed. If no value is specified in the first row, no action is taken. Any existing values will be overwritten with the value from the first row. The dropdown defaults to a blank value. The text entry field defaults to a blank value.
GeneChip
   Name: Read-Only. This field is prepopulated with the system generated GeneChip Name. The name was generated when the form was created.
   Chip Type: Dropdown—Required (checked when submit for witnessing initiated). Indicates which type of GeneChip is being used. Clicking on the “Filldown” link will set the Chip Type for each row equal to the values specified in the first row for all samples that have not been removed. If no value is specified in the first row, no action is taken. Any existing values will be overwritten with the value from the first row. The dropdown defaults to a blank value.
   Post Hyb. 2-8 Hold: Dropdown—Optional; alphabetical order (However, if a value is selected from the Dropdown, start and end times must also be entered. Checked when submit for witnessing initiated.)
      Start time: Text entry—Optional (checked when submit for witnessing initiated). Time entered in military format (HHMM). Four whole numbers only. HH must <=23. MM must be <=59.
      Stop time: Text entry—Optional (checked when submit for witnessing initiated). Time entered in military format (HHMM). Four whole numbers only. HH must <=23. MM must be <=59.
   Post Staining 2-8 Hold: Dropdown—Optional; alphabetical order (However if a value is selected from the Dropdown, start and end times must also be entered). This is the location that the GeneChip may be stored in after it is stained and before it is scanned. The first part is the freezer dropdown. The dropdown contains all of the active freezers and refrigerators. The second part is 2 text entry fields where the user enters the start and end time (HHMM) for the refrigerator hold. Clicking on the “Filldown” link will set the refrigerator and the start and end time for each row equal to the values specified in the first row for all samples that have not been removed. If no value is specified in the first row, no action is taken. Any existing values will be overwritten with the value from the first row. The dropdown defaults to a blank value. The text entry fields default to a blank value.
      Start time: Text entry—Optional (checked when submit for witnessing initiated). Time entered in military format (HHMM). Four whole numbers only. HH must <=23. MM must be <=59.
      Stop time: Text entry—Optional (checked when submit for witnessing initiated). Time entered in military format (HHMM). Four whole numbers only. HH must <=23. MM must be <=59.
Comments: Read-Only—Required if the Remove checkbox was selected. (checked when submit for witnessing initiated). Comments are displayed in read-only mode on the screen and are editable by clicking on the Edit Comment link.

A “Submit” button is found at the bottom of the page below all the rows of samples. Clicking Submit commits the form data to the database and returns user to main form page. The following verifications are done at this time:
Nickname is required.
Nickname is unique.
Hybmix Barcode is unique.
HHMM must be four whole numbers only.
HH must <=23.
MM must be <=59.
Verify Freezer Section/Box does not exceed 40 characters.

If any verification fails, an appropriate error message will appear on the page in red.

3. Fragmentation of cRNA

The Fragmentation of cRNA section is broken into three separate subsections, each with it's own maintenance form. The three sections are Equipment, Reagents and Storage. Each is described below.

a. Equipment

This section allows the user to associate which equipment will be used to complete the Fragmentation of cRNA process. The default equipment types that should be listed in this section are Pipet (listed 4 times), and Thermal Cycler.

b. Reagents

This section allows the user to associate which reagents will be used to complete the Fragmentation of cRNA process. The default reagent type is 5× Fragmentation Buffer.

c. Storage

The storage section contains two items.
Store the fragmented cRNA at −70° C. until hybridization.
Freezer Location: Dropdown—Optional; alphabetical order; Text entry—Optional; 40 chars. The freezer location is made up of two values. The first part is the freezer dropdown. The dropdown contains all of the active freezers in the database. The second part is a text entry field where the user enters the rack and box location within the specified freezer. The same location is used for all samples. This is an optional value as the user may choose to continue on with the next step of the process and not store the Samples in the freezer.

Defaults to “N/A” if no selection.
Comments: Read-Only. Comments are displayed in read-only mode on the screen and are editable by clicking on the Edit Comment link.

A “Submit” button is found at the bottom of the page below all the rows of samples. Clicking the Submit button commits the form data to the database and returns user to main form page. The following verifications are done at this time:
Verify Freezer Section/Box does not exceed 40 characters.

If any verification fails, an appropriate error message will appear on the page in red.

4. Hybridize Fragmented cRNA to GeneChip

The Hybridize Fragmented cRNA to GeneChip section is broken into three separate subsections, each with its own maintenance form. The three sections are Equipment, Reagents and Hybridize. Each is described below.

a. Equipment

This section allows the user to associate which equipment will be used to complete the Hybridize Fragmented cRNA to GeneChip process. The default equipment types that should be listed in this section are GeneChip Hybridization Oven, Microcentrifuge, Pipet (listed 4 times), Thermal Cycler.

b. Reagents

This section allows the user to associate which reagents will be used to complete Hybridize Fragmented cRNA to GeneChip process. The default reagent types are 2× Hybridization Buffer, Acetylated BSA (50 mg/mL), DMSO, GeneChip Hybridization Control Kit, Herring Sperm DNA (10 mg/mL), and RNase/DNase-free water.

c. Hybridize

The Hybridize section is broken into 5 steps as described below.

1. Prepare Hybridization Master Mix for n+1 reactions as follows: Below this note is the following read-only table containing preset and calculated amounts of each component to be used. The calculations (N+1 Reactions (μ)) are based on the numbers of samples (n) plus 1 then times the row's associated Per Reaction value (x). If a Sample has been removed, it is still counted in the total number of samples. This section also lists the Total Volume for all of the components. This section also lists the Total Volume for all of the components. The following table lists each component and the amount added per Sample.

| | Per Reaction | | n + 1 Reactions |
|---|---|---|---|
| Component | (μL) | | (μL) |
| Control Oligo B2 (3 nM) | 5 | μL | <n + 1> * x μL |
| 20X Spikes (bioB, bioC, bioD & cre) | 15 | μL | <n + 1> * x μL |
| Herring Sperm DNA (10 mg/mL) | 3 | μL | <n + 1> * x μL |
| Acetylated BSA (50 mg/mL) | 3 | μL | <n + 1> * x μL |
| 2X Hybridization Buffer | 150 | μL | <n + 1> * x μL |
| DMSO | 30 | μL | <n + 1> * x μL |
| RNase/DNase-free water | 64 | μL | <n + 1> * x μL |
| Total Volume | 270 | μL | <n + 1> * x μL |

2. Prepare 1× hybridization Buffer by diluting 2× Hybridization Buffer 1:1: <a> “mL 2× Hybridization Buffer+”<b> “mL RNase/DNase-free water.” Read only notes with 2 imbedded data entry text boxes (<a>, <b>)—Required (checked when submit for witnessing initiated). Whole and decimal numbers greater than 0.
3. Pre-heat the GeneChip (filled with 1× Hybridization Buffer), with approximately 60 rpm rotation, at 45° C. for 15 (±5) minutes.: Read only note
   Start Time: Text box—Required (checked when submit for witnessing initiated). Time entered in military format (HHMM). Four whole numbers only. HH must <=23. MM must be <=59.
   End Time: Text box—Required (checked when submit for witnessing initiated). Time entered in military format (HHMM). Four whole numbers only. HH must <=23. MM must be <=59.
4. Incubate the GeneChip (filled with Hybridization Mix) in the Hybridization Oven at 45° C., totaling at approximately 60 rpm and hybridize 15-17 hours.: Read only note
   Start Time: Text box—Required (checked when submit for witnessing initiated). Time entered in military format (HHMM). Four whole numbers only. HH must <=23. MM must be <=59.
   End Time: Text box—Required (checked when submit for witnessing initiated). Time entered in military format (HHMM). Four whole numbers only. HH must <=23. MM must be <=59.
5. Store the remaining mix(es) at −70° C. for later use.: Read only note
   Freezer Location: Dropdown—Required (checked when submit for witnessing initiated); alphabetical order; Text entry—Required (checked when submit for witnessing initiated); 40 chars (checked when submit form). The freezer location is made up of two values. The first part is the freezer dropdown. The dropdown contains all of the active freezers in the database. The second part is a text entry field where the user enters the rack and box location within the specified freezer. The same location is used for all samples. This is an optional value as the user may choose to continue on with the next step of the process and not store the Samples in the freezer.
Comments: Read-Only. Comments are displayed in read-only mode on the screen and are editable by clicking on the Edit Comment link.

A “Submit” button is found at the bottom of the page below all the rows of samples. Clicking the “Submit” button commits the form data to the database and returns user to main form page. The following verifications are done at this time:
HHMM must be four whole numbers only.
HH must <=23.
MM must be <=59.
Verify Freezer Section/Box does not exceed 40 characters.

If any verification fails, an appropriate error message will appear on the page in red.

5. Washing and Staining of GeneChips

The Washing and Staining of GeneChips section is broken into three separate subsections, each with its own maintenance form. The three sections are Equipment, Reagents and Washing/Staining. Each is described below.

a. Equipment

This section allows the user to associate which equipment will be used to complete the Washing and Staining of GeneChips process. The default equipment types that should be listed in this section are GeneChip Fluidics Station, GeneChip Scanner 3000, Pipet (listed 4 times).

b. Reagents

This section allows the user to associate which reagents will be used to complete the Washing and Staining of GeneChips process. The default reagent types are 2× Stain Buffer, Acetylated BSA (50 mg/μL), Biotinylated anti-streptavidin antibody (0.5 mg), Goat IgG (10 mg/mL), Non-Stringent Wash Buffer, RNase/DNase-free water, SAPE (1 mg/μL) (Streptavidin phycoerythrin), and Stringent Wash Buffer.

c. Washing/Staining

The Washing/Staining section is broken into 5 steps.
1. Remove the hybridization mix from the GeneChip and store at −70° C. Freezer Location: <x>: Read-only; <x> is combination of dropdown and text entry listed below. Dropdown—Required; alphabetical order (checked when submit for witnessing initiated). Text entry—Required; 40 chars (checked when submit for witnessing initiated). The freezer location is made up of two values. The first part is the freezer dropdown. The dropdown contains all of the active freezers in the database. The second part is a text entry field where the user enters the rack and box location within the specified freezer.
2. Probe array completely and fill with “<a> ” μL Non-stringent Wash Buffer.: Read only notes with 1 imbedded data entry text box (<a>)—Required (checked when submit for witnessing initiated). Whole and decimal numbers greater than 0.

3. Prepare SAPE Stain Solution for n+2 GeneChips as follows: Read-only note. Below this note is the following read-only table containing both preset and imbedded calculated amounts of each component to be used. The calculated amounts (<b>=(n+2)*x) are based on the numbers of samples (n) plus 2 then times the row's associated Per GeneChip value (x). If a Sample has been removed, it is still counted in the total number of samples. This section also lists the Total Volume for all of the components. The following table lists each component and the amount added per Sample.

| | | | n + 2 |
|---|---|---|---|
| | Per | | GeneChip |
| Component | GeneChip | | (3) |
| 2X Stain Buffer | 600 | μL | <b> μL |
| RNase/DNase-free water | 540 | μL | <b> μL |
| Acetylated BSA (50 mg/mL) | 48 | μL | <b> μL |
| SAPE (1 mg/mL) | 12 | μL | <b> μL |
| Total Volume | 1200 | μL | <b> μL |

4. Prepare the Antibody Solution Mix for n+1 GeneChips as follows: Read-only note. Below this note is the following read-only table containing preset and calculated amounts of each component to be used. The calculations (<c>=(n+1)*x) are based on the numbers of samples (n) plus 1 then times the row's associated Per GeneChip value (x). If a Sample has been removed, it is still counted in the total number of samples. This section also lists the Total Volume for all of the components. This section also lists the Total Volume for all of the components. The following table lists each component and the amount added per Sample.

| | | | n + 1 |
|---|---|---|---|
| | Per | | GeneChip |
| Component | GeneChip | | (3) |
| 2X Stain Buffer | 300 | μL | <c> μL |
| RNase/DNase-free water | 266.4 | μL | <c> μL |
| Acetylated BSA (50 mg/mL) | 24 | μL | <c> μL |
| Goat IgG | 6 | μL | <c> μL |
| Biotinylated anti-streptavidin | 3.6 | μL | <c> μL |
| antibody (0.5 mg) | | | |
| Total Volume | 600 | μL | <c> μL |

5. Fluidics Station Protocol: Dropdown—Required (checked when submit for witnessing initiated). List of all active Fluidics Protocols that are available. List defaults to blank.
Comments: Read-Only. Comments are displayed in read-only mode on the screen and are editable by clicking on the Edit Comment link.

A “Submit” button is found at the bottom of the page below all the rows of samples. Clicking “Submit” commits the form data to the database and returns user to main form page.

6. Comments: These are general comments that the user can enter that apply to the entire form. Comments are displayed in read-only mode on the screen and are editable by clicking on the Edit Comment link.

A “Submit” button is found at the bottom of the page below all the rows of samples. Clicking “Submit” commits the form data to the database and returns user to main form page.

The following sections detail which fields require witnessing on the Hybridization form.
1. Header: There are no fields that require witnessing in the header.
2. Sample Identification: Every row in the Sample Identification table requires witnessing.
3. Fragmentation of cRNA
   a. Equipment: Every row in the table requires witnessing.
   b. Reagent: Every row in the table requires witnessing.
   c. Fragmentation: If a freezer was specified it must be witnessed. If comments have been supplied, they must also be witnessed.
4. Hybridize Fragmented cRNA to GeneChip
   a. Equipment: Every row in the table requires witnessing.
   b. Reagent: Every row in the table requires witnessing.
   c. Hybridize: The 2× Hybridization buffer and RNase/DNase-free water amounts must be witnessed. All start and end times must be witnessed. If a freezer was specified it must be witnessed. If comments have been supplied, they must also be witnessed.
5. Washing and Staining of GeneChips
   a. Equipment: Every row in the table requires witnessing.
   b. Reagent: Every row in the table requires witnessing.
   c. Washing/Staining: If a freezer was specified it must be witnessed. The Non-stringent Wash Buffer amount and Fluidics Station Protocol must be witnessed. If comments have been supplied, they must also be witnessed.
6. Comments: If a comment was supplied, it must be witnessed.

13. Inventory-Reagents

The Add/Edit Reagents Home Page displays a set of filters to maintain available Reagents. The following fields can be shown to the user.
Reagent Type: This dropdown is populated from table REAGENTTYPE and is a list of all DESCRIPTION in order by ORDEREDBY (desc), DESCRIPTION (ascending, not case sensitive). If an entry is selected it will further filter the list of Descriptions based on the Reagent Type selected and the Show entry selected.
Description: This listbox is populated with a concatenated value of ReagentType_ReagentManufacturer_LotNumber of all available reagents based on the Active/Inactive selection and Reagent Type filter.

Links titled “active” and “inactive” can be used to filter the reagents listed in the Description listbox. Only one link can be selected at a time. The selected link shows without an underline.

Buttons labeled “Add” and “Edit” are available to the user. The Add button opens the “Add Reagent” form. When the Edit button is clicked, the application verifies that a selection has been made in the Description listbox. If no selection has been made, a pop up appears with an appropriate error message indicating that a selection is required. An OK button is available.

Clicking the OK button returns the user to the Add/Edit Reagents home page. If a selection has been made, the “Edit Reagent” page opens up. All associated fields are pre-populated.

In the Add and Edit forms, the following fields are provided:
Reagent Type: This dropdown, a required field, is populated from table REAGENTTYPE and is a list of all active DESCRIPTION in order by ORDEREDBY (desc), DESCRIPTION (ascending, case sensitive). The one exception is if the currently associated reagent type is currently inactivated, it will still show in this list.
Reagent Manufacturer: This dropdown is populated from table REAGENTMAN and is a list of all active DESCRIPTION in order by ORDEREDBY (desc), DESCRIPTION (ascending, case sensitive). The one exception is if the currently associated reagent manufacturer is currently inactivated, it will still show in this list.
Lot Number: This required text box is a case sensitive field.

The combination of these values entered for Reagent Type, Reagent Manufacturer, and Lot Number is a unique key for each record.
Expiration Date: This required text box is populated either by leaving the default (today), by typing another valid value in or by clicking the calendar button to the right of the field. The date must be entered in the dd-MMM-YYYY format.
Active: This checkbox indicates if the reagent is active or not. If the box is checked, the item is active and will show in the picklist when it appears for use in the application. By default for new items, the checkbox is checked. A value of 1 is stored for “Active” (checked) items. A value of 0 is stored for “Inactive” (unchecked) items.

The following fields have values that are read-only. They do not appear on the Add form, but the values are recorded against the record when submitted.
Created By: The first and last name of the user who initially added the item to the picklist.
Created Date: The date that the item was created. Can have the format Mon dd, yyyy HH:MM:SS AM/PM.
Last Modified By: The first and last name of the user who last modified the picklist. This value is blank until the item's first edit is committed to the database.
Last Modified Date: The date that the item was last modified. This value is blank until the item's first edit is committed to the database. Can be formatted Mon dd, yyyy HH:MM:SS AM/PM.

The following actions are available in the Reagent Inventory Add and Edit views.
Calendar: There is a calendar popup button to the right of each date field. This popup enables the user to select a date in the current month (default; today's date shows in color), or navigate backwards or forwards by month (<0 >) or by year (<< >>) to select another date. Clicking that date closes the popup and populates the associated date field with the selected date in proper format.

Below all the fields, the following buttons appear.
Submit: This button initiates committing the data to the database. An appropriate error message will be provided if the following verifications do not pass:
   1) all required fields are completed
   2) Reagent Type, Reagent Manufacturer, Lot Number combination must be unique. If it is not, an error message shows at top of page stating that the Reagent Type, Reagent Manufacturer, Lot Number combination already exists in the system.
   3) all date fields are in valid format. If not, an error message shows at the top of the page stating: Expiration Date is not in proper format (dd-Mon-YYYY).
   4) all dates must be valid dates (i.e. ABC, 29-Feb-2005). If not, an error message shows at the top of the page stating: Expiration Date is not a valid date.
   5) Expiration date cannot be before “Today”. If not, an error message shows at the top of the page stating: Expiration Date cannot be earlier than today's date.
If all the verifications are met, the data is committed to the database, and the user is returned to the Maintain Reagents home page. The added/edited entry shows in the appropriate filter.
Cancel: Discards all data additions or changes and returns user to main form page.

14. Inventory—Samples

The sample inventory keeps records of samples to be processed according to the workflow. In general, a sample is a specimen of biological material to be studied as part of a drug discovery or development program. The sample can be, for example, cell samples from a cell culture in a preclinical study, tissue samples taken from non-human animals in a preclinical study, or tissue sample from a human in a clinical trial. Sample inventory records can include information regarding the type of sample (cell, tissue, tissue type), origin (species, subject ID), name drug administered to subject, dose, timepoint, unique sample ID, or any other desired information.

The Add/Edit Samples Home Page displays a set of filters to maintain available Samples. They are listed top to bottom. All fields default to no selection. The following fields will be shown:
Study: This dropdown is populated from table STUDY and is a list of all STUDYID for those studies associated with samples in order by STUDYID (ascending, not case sensitive). If an entry is selected it will further filter the list of Descriptions based on the Study ID selected.
Tissue Type: This dropdown is populated from table TISSUETYPE and is a list of all DESCRIPTION in order by ORDEREDBY (desc), DESCRIPTION (ascending, not case sensitive). If an entry is selected it will further filter the list of Descriptions based on the Tissue Type selected.
Description: This listbox is populated with a concatenated value of LIMSID/NAME (in order by tissuesample.limsid, tissuesample.name) of all available samples based on the Active|Inactive selection and the Study and Tissue Type filters.

The following actions are available as links. Only one link can be selected at a time. The selected link shows without an underline.
Active: Refilters to show all the active Description in the list box. By default Active is selected.
Inactive: Refilters to show all the inactive Description in the list box

The following two buttons are available:
Add: The application opens the “Add Sample” form.
Edit: The application verifies that a selection has been made in the Description listbox. If no selection has been made, a pop up appears with an appropriate error message indicating that a selection is required. An OK button is available. Clicking the OK button returns the user to the Add/Edit Samples home page. If a selection has been made, the “Edit Sample” page opens up. All associated fields are populated.

The Add/Edit form is the same format for both adding and editing samples. The only differences are the title, whether or not the data is pre-populated and whether or not audit fields are hidden or available and null or populated.

In the ADD mode, all fields default to no selection or <null> unless otherwise noted. In the EDIT mode, all fields are populated with the associated field data. The following fields are shown:
Sample Name: Read-only—System generated.
Short Name: Read-only—System generated.
Barcode: Text field—Required; integer (max 10 digits). Can be read in to system via barcode scanner.
LIMS ID: Text field—Required. Can be pre-populated from an external LIMS system.

The fields that make up the unique record for a Sample include Barcode and LIMS ID, which is case sensitive.
Study: This required dropdown is populated from table STUDY and is a list of all active STUDYID in order by STUDYID (ascending, not case sensitive), uniqueid (ascending). The exception to this rule is if the sample being edited is associated with an inactive study, it will show in the list.
Subject ID: Text field—Required. The subject ID identifies the particular subject (e.g., mouse, rabbit, rat, human) from which the sample is derived.
Tissue Type: This required dropdown contains a list of all active Tissue Types. This dropdown is populated from table TISSUETYPE and is a list of all active DESCRIPTION in order by ORDEREDBY (desc), DESCRIPTION (ascending, not case sensitive). The exception to this rule is if the sample being edited is associated with an inactive tissue type, it will show in the list.
Timepoint: Text field—Required. Record of the timepoint (e.g., number of hours after drug/vehicle administration) that the sample was taken.
Route: Required dropdown displays the list of all active Routes. This dropdown is populated from table ROUTE and is a list of all active DESCRIPTION in order by ORDEREDBY (desc), DESCRIPTION (ascending, case sensitive). The exception to this rule is if the sample being edited is associated with an inactive route, it will show in the list. Records the route by which the drug was administered to the subject. Exemplary values can include oral, intravenous, subcutaneous, intramuscular, intraperitoneal, etc.
Group Name: Text field
Dose: Text entry—Required. The user enters the dose as a numeric value (whole, decimal, zero).
Dose Units: Dropdown—Required; alphabetical order. This dropdown is populated from table DOSEUNITS and is a list of all active DOSEUNITSDESCRIPTION in order by ORDEREDBY (desc), DOSEUNITSDESCRIPTION (ascending, case sensitive). The exception to this rule is if the sample being edited is associated with an inactive dose unit, it will show in the list.
Freezer Location: Dropdown—Required. This dropdown is populated from table FREEZERLOCATION and is a list of all active FREEZERLOC in order by FREEZERLOC (ascending, case sensitive). The exception to this rule is if the sample being edited is associated with an inactive freezer, it will show in the list. Records the location of the freezer in which the sample is stored.
Freezer Section/Box: Text entry—Required. A text entry field where the user enters the section and box location within the specified freezer. The two Freezer fields together allow a user to unambiguously locate a given sample in a laboratory having multiple freezers, each storing numerous samples.
Drug Name: Required dropdown contains a list of all active Drug Names. This dropdown is populated from table DRUGNAME and is a list of all active DESCRIPTION in order by DESCRIPTION (ascending, case sensitive). The exception to this rule is if the sample being edited is associated with an inactive drug name, it will show in the list. Identifies the drug administered to the subject.
Active: Checkbox; default=checked/active. Indicates if the sample is active or not. If the box is checked, the item is active and will show in the picklist when it appears for use in the application. By default for new items, the checkbox is checked. A value of 1 is stored for “Active” (checked) items. A value of 0 is stored for “Inactive” (unchecked) items.
Notes: Text field. Allows a user to enter any desired notes associated with the sample.

The following read-only fields will be shown. They do not appear on the Add form, but the values are recorded against the record when submitted.
Created By: The first and last name of the user who initially added the item.
Created Date: Read-Only—Formatted “Mon dd, yyyy HH:MM:SS AM/PM”. The date that the item was created.
Last Modified By: Read-Only. The first and last name of the user who last modified the item. This value is blank until the item's first edit is committed to the database.
Last Modified Date: Read-Only—Formatted “Mon dd, yyyy HH:MM:SS AM/PM” The date that the item was last modified. This value is blank until the item's first edit is committed to the database.

Below all the fields, the following buttons appear:
Submit: This button initiates committing the data to the database. An appropriate error message will be provided if the following verifications do not pass:
   1) all required fields are completed
   2) Combination of Barcode and LIMS ID must be unique. LIMS ID is case sensitive (a<>A). If it is not, an error message shows at top of page stating: The Barcode/LIMS ID combination already exists in the system.
Otherwise, the data is committed to the database, and the user is returned to the Add/Edit Samples home page. The added/edited entry shows in the appropriate Description filter.
Cancel: Discards all data additions or changes and returns user to main form page.

15. Program Maintenance

The system provides the ability to maintain the list of programs, subprograms, studies and experiments that are used to categorize records. The program maintenance main page lists programs by status (active or inactive). The user can select a program to edit, or add a new program.

In the ADD mode, the title states Add Program and all fields default to no selection or <null> in the add mode unless otherwise noted. In the EDIT mode, the title states Edit Program and all fields are populated with the associated field data. The following fields are shown:
Trade Name: Text Field—Required if Generic Name not entered; Unique; 64 chars. The trade name of a drug or drug candidate being studied.
Generic Name: Text Field—Required if Trade Name not entered; Unique; 64 chars. The generic name of a drug or drug candidate being studied.
Description: Text Field—Required; 2000 chars. A description of the program.
Active: Checkbox. Active=checked; Inactive=not checked.
Tracking Number: Read-only. In ADD mode, this number is temporarily generated prior to saving to the database, but if the program is not created successfully, the number is not used. Number is generated by taking highest number in the database and adding one hundred. (NOTE: a duplicate number could be created if 2 people create program at same time. Since there will only be 2 or 3 programs created each year, it was decided that this issue will be resolved post-release 1.)
Team Representative: Dropdown. Required. List of all active users in the database “Lastname, Firstname”. Sorted alphabetically by lastname, firstname, case insensitive

The values of the following fields are read-only. They do not appear on the Add form but the values are recorded against the record when submitted.
Created By: Read-Only. The first and last name of the user who initially added the item.
Created Date: Read-Only—Formatted “Mon dd, yyyy HH:MM:SS AM

/PM”. The date that the item was created.
Last Modified By: Read-Only. The first and last name of the user who last modified the item. This value is blank until the item's first edit is committed to the database.
Last Modified Date: Read-Only—Formatted “Mon dd, yyyy HH:MM:SS AM/PM”. The date that the item was last modified. This value is blank until the item's first edit is committed to the database.

The following buttons are found at the bottom of the page:
Submit: Commits the form data to the database and returns user to main form page. The following verifications are done at this time:
   All required fields are completed.
   Trade Name is unique to the system, if entered.
   Generic Name is unique to the system, if entered.
If any verification fails, an appropriate error message will appear at the top of the page in red.
Cancel: Discards all data additions or changes and returns user to main form page

16. Subprogram Maintenance

Subprogram maintenance operates like program maintenance, described above. The following fields are associated with a subprogram:
Name: Text Field—Required; Unique case insensitive; 64 chars.
Description: Text Field—Required; 2000 chars.
Subprogram ID number: Text Field; 64 chars.
Active: Checkbox. Active=checked; Inactive=not checked.
Program: Dropdown—Required. Concatenated all active “Generic Name—Trade Name”. If no generic name, only trade name. If no trade name, only generic name. Sorted alphabetically case insensitive. The exception to this rule is if the entry selected is associated with an inactive program, that inactive program will also show in the list.

The values of the following fields are read-only. They do not appear on the Add form but the values are recorded against the record when submitted.
Created By: Read-Only. The first and last name of the user who initially added the item.
Created Date: Read-Only—Formatted “Mon dd, yyyy HH:MM:SS AM/PM”. The date that the item was created.
Last Modified By: Read-Only. The first and last name of the user who last modified the item. This value is blank until the item's first edit is committed to the database.
Last Modified Date: Read-Only—Formatted “Mon dd, yyyy HH:MM:SS AM/PM”. The date that the item was last modified. This value is blank until the item's first edit is committed to the database.

17. Study Maintenance

Study maintenance operates like program maintenance, described above. The following fields are associated with a study:

Fields listed in the table are matrixed by study type in the following fashion:

| PC | Cl | Re | PD | FIELD | CHARACTERISTICS |
|---|---|---|---|---|---|
| R | R | R | R | Study ID | Text box-required |
| | | | | | 64 characters |
| | | | | | Editable |
| R | R | R | R | Tracking number | Autogenerated after save-required, unique. |
| | | | | | ALWAYS readonly |
| R | R | R | R | Study title | text box-required, unique to table |
| | | | | | 64 characters |
| | | | | | editable |
| R | R | R | R | Rationale | text box-required |
| | | | | | 256 characters |
| | | | | | editable |
| X | | | | Initiation | DATE |
| | | | | | Editable |
| X | | | | Termination | DATE |
| | | | | | Editable |
| R | R | R | R | Species | Dropdown |
| | | | | | Contents: all active(*) species.description |
| | | | | | Editable |
| X | X | X | X | Monitor | Dropdown |
| | | | | | Contents: all active(*) Monitor.description |
| X | X | X | X | Indication | Dropdown |
| | | | | | Contents: all active(*) Indication.description |
| R | | | | CRO | Dropdown |
| | | | | | Contents: all active(*) |
| | | | | | CRO.description |
| R | R | R | R | Sub-Program | Dropdown-required |
| | | | | | Contents: all active(*) Subprogram.name |
| | | | | | Editable |
| R | | | | CRO Study Director | Textbox - 64 chars |
| | | | | | Editable |
| X | | | | CRO Study number | Text box - 64 char |
| | | | | | Editable |
| X | | | | CRO pathologist | Textbox - 64 chars |
| | | | | | Editable |
| | X | | | First Patient In | DATE |
| | | | | | Editable |
| | | | | | Defaults to date was created. |
| | X | | | Lock Date | DATE |
| | | | | | Editable |
| | | | | | Defaults to date was created. |
| | X | | | Last Patient Out | DATE |
| | | | | | Editable |
| | | | | | Defaults to date was created. |
| X | X | X | X | Expected Sample Count | Integer |
| | | | | | allow zero |
| X | X | X | X | Active | checkbox (Yes/No) |
| | | | | | Defaults to Checked = Yes |
| X | | | | Biogen Pathologist | Textbox - 64 chars |
| | | | | | Editable |
| X | X | X | X | Development Protocol | Date |
| | | | | Completion Forecast Date | Editable |
| | | | | | Defaults to date was created. |
| X | X | X | X | Development Protocol | Date |
| | | | | Completion Actual Date | Editable |
| | | | | | Defaults to date was created. |
| X | X | X | X | Sample Received Forecast Date | Date |
| | | | | | Editable |
| | | | | | Defaults to date was created. |
| X | X | X | X | Sample Received Actual Date | Date |
| | | | | | Editable |
| | | | | | Defaults to date was created. |
| X | X | X | X | Lab Work Initiation Forecast | Date |
| | | | | Date | Editable |
| | | | | | Defaults to date was created. |
| X | X | X | X | Lab Work Initiation Actual | Date |
| | | | | Date | Editable |
| | | | | | Defaults to date was created. |
| X | X | X | X | Lab Work Completion Forecast | Date |
| | | | | Date | Editable |
| | | | | | Defaults to date was created. |
| X | X | X | X | Lab Work Completion Actual | Date |
| | | | | Date | Editable |
| | | | | | Defaults to date was created. |
| X | X | X | X | Lab Work Witness Forecast | Date |
| | | | | Date | Editable |
| | | | | | Defaults to date was created. |
| X | X | X | X | Lab Work Witness Actual Date | Date |
| | | | | | Editable |
| | | | | | Defaults to date was created. |
| X | X | X | X | Submit Report Completion | Date |
| | | | | Forecast Date | Editable |
| | | | | | Defaults to date was created. |
| X | X | X | X | Submit Report Completion | Date |
| | | | | Actual Date | Editable |
| | | | | | Defaults to date was created. |
| X | X | X | X | Final Report Completion | Date |
| | | | | Forecast Date | Editable |
| | | | | | Defaults to date was created. |
| X | X | X | X | Final Report Completion Actual | Date |
| | | | | Date | Editable |
| | | | | | Defaults to date was created. |

PC = Pre Clinical
Cl = Clinical
Re = Research
PD = Product Development
R = Required field
X = included on form
<null> = not included on form
(*)The exception to the “all active” rule is if the entry selected is associated with an inactive item, that inactive item will also show in the appropriate list.

The values of the following fields are read-only. They do not appear on the Add form but the values are recorded against the record when submitted.
Created By: Read-Only. The first and last name of the user who initially added the item.
Created Date: Read-Only—Formatted “Mon dd, yyyy HH:MM:SS AM/PM”. The date that the item was created.
Last Modified By: Read-Only. The first and last name of the user who last modified the item. This value is blank until the item's first edit is committed to the database.
Last Modified Date: Read-Only—Formatted “Mon dd, yyyy HH:MM:SS AM/PM”. The date that the item was last modified. This value is blank until the item's first edit is committed to the database.

18. Experiment Maintenance

Experiment maintenance operates like program maintenance, described above. The following fields are associated with an experiment:
Protocol Title: Text Field—Required; Unique; 64 chars.
Rationale: Text Field—64 chars.
Expected Chip Count: Text Field—Integer >=0
Protocol Number: Text Field—Integer >=0
Active: Checkbox. Active=checked; Inactive=not checked.
Lead Scientist: Dropdown—Required. List of “Lastname, Firstname” of all active users in the system. The exception to this rule is if the entry selected is associated with an inactive item, that inactive item will also show in the list.
Study: Dropdown—Required. All active Study ID. Sorted alphabetically case insensitive. The exception to this rule is if the entry selected is associated with an inactive item, that inactive item will also show in the list.

19. Picklist Maintenance

Certain fields in the system are populated with a controlled list of options (e.g., equipment fields, where the list of options corresponds to equipment available to performers). These picklists are editable as new options for the list become available or existing options cease to be available to performers. Specifically, the following fields have associated picklists that need to be maintained:
Equipment Manufacturer
Equipment Type
Reagent Manufacturer
Reagent Type
Route
Tissue Type
Species
Monitor
Indication
CRO
User Roles
Freezer Location

Each of the above picklists is maintained on its own picklist maintenance page. The Main Page displays a list of all of the Active entries for that picklist. From the picklist maintenance main page, the user can select the following actions:
Filter—User can filter the list to display only the active or inactive items. By default the filter is set to “Active”.
New—Clicking the new button will take the user to a blank form where they can add a new picklist item.
Edit—Selecting an item and clicking the edit button will take the user to a form where they can edit the selected entry's attributes.
Delete—Clicking the delete button will remove the selected entry from the database. Entries can only be removed if there are no relations to that data in the database. Referential integrity must be maintained. Before the delete is performed, the user is prompted with a confirmation box.

Selecting “New” or “Edit” takes the user to an Add/Edit form. The Add/Edit form is the same format for both adding and editing picklist items. The only difference is whether or not the data is prepopulated. The following fields are available:
Description: Text Entry. The value enter for the description is the same value that will be displayed in the picklist. The description must be unique for each picklist.
Sort Order: Text Entry. Indicates the order in the list that the item should appear. Picklist items are sorted first by the value in this field (in descending order) and then by description. By default all entries have a value of zero, therefore the items are sorted alphabetically. The item with the highest sort order value will appear first in the list.
Active: Checkbox. Indicates if the picklist item is active or not. If the box is checked, the item is active and will be in the picklist when it appears on a form. By default the checkbox is checked.
Created By: Read-Only. The first and last name of the user who initially added the item to the picklist. When adding a new value to a list, this value is blank until the item is committed to the database.
Created Date: Read-Only. The date that the item was first created. When adding a new item, this field is blank until the item is committed to the database.
Last Modified By: Read-Only. The first and last name of the user who last modified the picklist. The value is not updated until the item is committed to the database.
Last Modified On: Read-Only. The date that the item was last modified. When editing an existing item, this field is not updated until the changes are committed to the database.

The following actions are available:
Submit—Commits the form data to the database and returns user to main picklist page.
Cancel—Discards all data additions or changes and returns user to main picklist page.

20. System Architecture

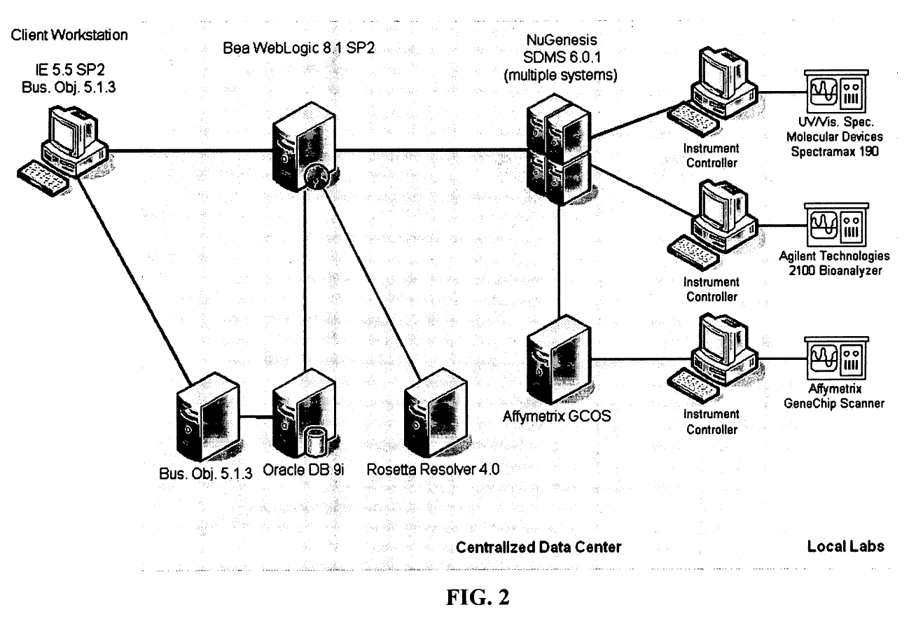

High-level depictions of the architecture for the system appear in the FIG. 2. One is an illustration of the application's logic, and the second illustrates the components of its technology.

The majority of the application is implemented in a traditional three-tier architecture. The business logic is written in Java, and served to the client's browser via a BEA WebLogic server. Data storage is provided by an Oracle relational database.

Hybridization data is produced by and acquired from an Affymetrix GENECHIP brand array. Quality control data for samples is produced by UV/Vis spectrophotometers. Some UV/Vis information is manually transcribed to the form. However, the system can be configured such that the UV/Vis information (or other information collected by instrumentation) is automatically transcribed to the form. For example, the spectrophotometers (or other instruments) can store their output on a file server, where the relevant information can be directly parsed by the application. Analysis of gene expression data is performed using Rosetta Resolver tools.

A future release of the application will store all raw and processed data, as well as copies of final reports, in a NuGenesis SDMS Archive.

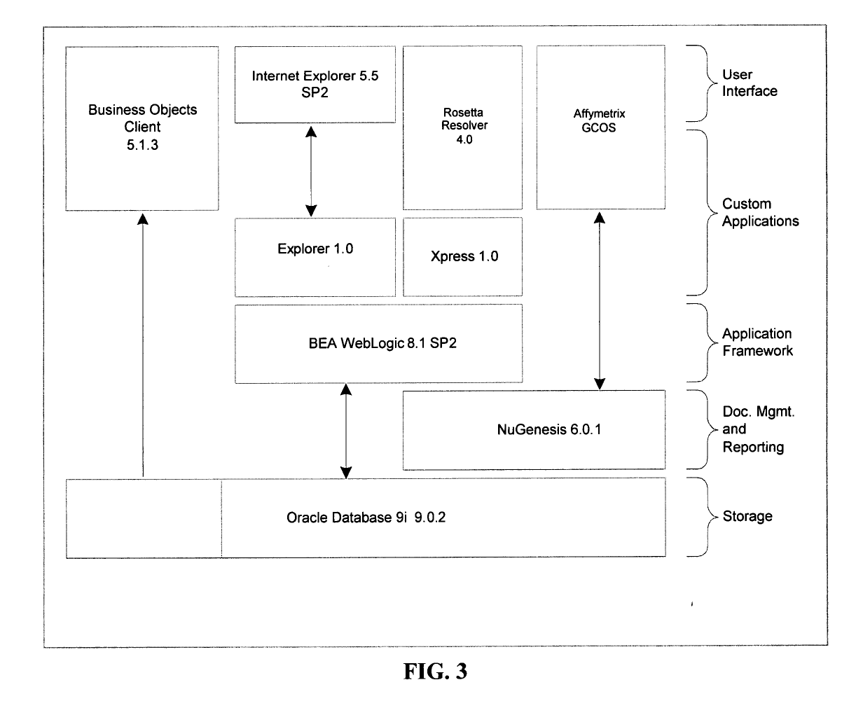

FIG. 3 illustrates the technology stack used by the various components of the application. This application was design and developed utilizing the OMG's Model Driven Architecture (MDA) standard. This standard produces standards based J2EE code from UML models. All code generated by OptimalJ uses Sun Microsystems core J2EE patterns. See, for example, Implementing Sun Microsystems' Core J2EE Patterns; and also, OptimalJ: How transformation patterns transform UML models into high-quality J2EE, each of which is incorporated by reference in its entirety.

The system design is divided into eight major components.
OptimalJ
Java Server Pages (JSPs)
Enterprise Java Beans (EJBs)
Action Classes
Action Forms
Oracle Functions
Data Access Objects
Triggers

All source code, with the exception of Oracle functions and Triggers, is stored in a CVS repository. CVS was chosen because OptimalJ integrates best with CVS. Additional information regarding the CVS integration with OptimalJ can be found in the document, Working With CVS.

The source code for the Oracle functions and for Triggers is located within the database. Detailed documentation on all Java source code (Action Classes, Action Forms, Value Objects, Data Access Objects, EJBs, Utility Classes, etc.) can be generated by running the javadoc utility against the source code. The javadoc utility is supplied as part of Java Development Kit (JDK) 1.4.

A detailed description of the file types found in this application can be found in File Types Within OptimalJ, which is incorporated by reference in its entirety. This description includes both standard Java application files and OptimalJ-specific files.

OptimalJ and the Model Driven Architecture that it implements, represents a new paradigm in software development. When developing software, you must think about the model first and add as much detail to the model as possible. The model generates the source code (both Java and database DDL).

Java Server Pages are the client-side components that render the required information for a particular Web page. All pages use the Struts-tag libraries to coordinate with form data and action classes. JSP's facilitate the creation of user interfaces that are fully internationalized and that interact with action form beans.

Enterprise JavaBeans (EJB) technology is the server-side component architecture for the Java 2, Enterprise Edition (J2EE) platform. EJB technology enables rapid and simplified development of distributed, transactional, secure and portable applications based on Java technology. The application uses two categories of EJBs: entity beans and session beans. Entity beans are used to manage the creation, query, update, or deletion of data (entities). Session beans are used to manage software processes (sessions) that apply business logic and rules.

The action classes behave as the application's controller components, whose primary goal is to receive the request from the client, decide what business logic is to be performed, and delegate to an appropriate view component (JSP) the responsibility for producing the next phase of the user interface. By defining the action mappings in the Struts-config file, the action classes are configured to a particular action mapping, and the Struts framework will handle the rest.

Action forms, or form beans, should themselves be considered controller components. As such, they are able to transfer data between the model and view layers. The application has one action form for each user request, and the lifetime of the action form is defined in the struts-config file (mostly requests). Each form bean has a default validation method to validate the page, and a reset method to show the default value for the page.

Oracle functions are used primarily to assist in the generation of unique sample names. The functions are called from triggers on each of the sample-type tables (TISSUESAMPLE, HOMOGENATE, TOTALRNA, cRNA AND HYBRIDIZATION).

Data Access Objects (DAO) performs such database operations as read, write, and delete. EJBs are the primary interface to the database for inserts and updates. DAOs are primarily used as fast-lane readers to retrieve data from the database for display.

To assure compliance with 21 CFR part 11, an essential function of the system is to provide audit trails. These are achieved by means of triggers. After information is successfully saved in the database, the system creates an audit record in the mirrored table in the explorer_audit schema. Along with the data in question, the system also stores the action, date, and time of the transaction; the user who performed the transaction; and the transaction type (either INSERT or UPDATE).

The explorer_audit schema will be generated using the SQL script build_audit_tables.sql, and the audit triggers will be generated using the SQL script build_audit_triggers.sql. Both scripts can be found in the Visual SourceSafe project directory for this application.

The application uses both authentication and authorization routines. Authentication routines prevent unauthorized access by validating users who try to access the system. Authorization routines limit each authenticated user to functions that correspond to his/her defined roles. Authentication is performed by Novell's e-Directory server. Authorization privileges for any user can be granted by the system administrator when the user record is created. Each JSP page has a custom JSP tag that checks to ensure that the user has access to the page based on his/her role.

Other embodiments are within the scope of the following claims.

What is claimed is:

1. A method of keeping records, comprising:
recording on a computer-readable medium information entered by a first user to provide a first computer-readable record, and metadata associated with the first computer-readable record, wherein the metadata is protected from changes;
displaying the first computer-readable record to a second user for acknowledgement; and
recording, on a computer-readable medium, an acknowledgement by the second user of the information entered by the first user.

2. The method of claim 1, wherein recording the acknowledgement includes recording an approval or a disapproval of the information entered by the first user.

3. The method of claim 1, wherein the acknowledgement includes a comment by the second user.

4. The method of claim 2, wherein recording a disapproval includes requiring the second user to record a comment.

5. The method of claim 1, wherein the metadata associated with the first computer-readable record includes an identity of the first user, a date, a time, or a combination thereof.

6. The method of claim 1, wherein the information entered by the first user includes information describing a laboratory manipulation carried out by the first user.

7. The method of claim 6, wherein the laboratory manipulation is performed according to a standard operating procedure.

8. The method of claim 7, wherein the standard operating procedure specifies mandatory information describing the laboratory manipulation that must be recorded in order to comply with the standard operating procedure.

9. The method of claim 8, wherein the first user is required to enter the mandatory information.

10. The method of claim 6, wherein the information describing a laboratory manipulation includes a user identity, a sample identity, a sample description, an identity of a standard operating procedure, a version of a standard operating procedure, an equipment identity, a reagent identity, a reagent manufacturer, a reagent expiration date, a reagent amount, a reagent quantity, a start time of a manipulation, a stop time of a manipulation, a duration of a manipulation, an amplitude of a manipulation, a result of a measurement, an identity of a manipulated sample, a location of a manipulated sample, a user comment, or a combination thereof.

11. The method of claim 6, wherein the laboratory manipulation includes a manipulation related to a nucleic acid preparation, a nucleic acid purification, a nucleic acid labeling, a protein preparation, a protein purification, a protein labeling, a metabolite preparation, a metabolite purification, or a metabolite labeling.

12. The method of claim 6, wherein the laboratory manipulation includes a gene expression profiling experiment, an ELISA-based assay, a cell-based assay, a flow cytometry assay, a multiplex bead-based assay, a proteomics assay, a PCR-based assay, a spectrophotometric analysis, a gel electrophoresis experiment, a capillary electrophoresis experiment, or a combination thereof.

13. The method of claim 6, wherein the laboratory manipulation includes a manipulation related to tissue homogenization, total RNA preparation, cRNA preparation, or hybridization of cRNA to a DNA array.

14. The method of claim 1, further comprising recording on a computer-readable medium a comment from the first user when the second user disapproves of the first electronic record.

15. The method of claim 1, further comprising submitting the first computer-readable record to a regulatory agency.

16. The method of claim 1, further comprising recording on a computer-readable medium information entered by a first user to provide a second computer-readable record and metadata associated with the second computer-readable record to provide a collection of computer-readable records, wherein the metadata is protected from changes.

17. The method of claim 16, wherein the collection of computer-readable records is displayed to a second user for acknowledgement.

18. The method of claim 16, wherein the collection of computer-readable records describes a laboratory workflow.

19. The method of claim 16, further comprising modifying the collection by recording on a computer-readable medium a third computer-readable record and metadata associated with the third computer-readable record, wherein the third computer-readable record corresponds to and modifies an existing computer-readable record in the collection, wherein the existing computer-readable record and its associated metadata are retained in the collection.

20. The method of claim 16, further comprising recording on a computer-readable medium information entered by a first user to provide a plurality of computer-readable records and metadata associated with the each of the plurality of computer-readable records to provide a collection of computer-readable records, wherein the metadata is protected from changes.

21. The method of claim 20, further comprising generating an audit trail for the collection of computer-readable records from the metadata.

22. A computer program for record-keeping, the computer program comprising instructions for causing a computer system to:
record on a computer-readable medium information entered by a first user to provide a first computer-readable record, and metadata associated with the first computer-readable record, wherein the metadata is protected from changes;
display the first computer-readable record to a second user for acknowledgement; and
record, on a computer-readable medium, an acknowledgement by the second user of the information entered by the first user.

23. The computer program of claim 22, wherein the acknowledgement includes recording an approval or disapproval of the information entered by the first user.

24. The computer program of claim 22, wherein the acknowledgement includes a comment by the second user.

25. The computer program of claim 23, wherein recording a disapproval includes requiring the second user to record a comment.

26. The computer program of claim 22, wherein the metadata associated with the first computer-readable record includes an identity of the first user, a date, a time, or a combination thereof.

27. The computer program of claim 22, wherein the information entered by the first user includes information describing a laboratory manipulation carried out by the first user.

28. The computer program of claim 27, wherein the laboratory manipulation is performed according to a standard operating procedure.

29. The computer program of claim 28, wherein the standard operating procedure specifies mandatory information describing the laboratory manipulation that must be recorded in order to comply with the standard operating procedure.

30. The computer program of claim 29, wherein the first user is required to enter the mandatory information.

31. The computer program of claim 27, wherein the information describing a laboratory manipulation includes a user identity, a sample identity, a sample description, an identity of a standard operating procedure, a version of a standard operating procedure, an equipment identity, a reagent identity, a reagent manufacturer, a reagent expiration date, a reagent amount, a reagent quantity, a start time of a manipulation, a stop time of a manipulation, a duration of a manipulation, an amplitude of a manipulation, a result of a measurement, an identity of a manipulated sample, a location of a manipulated sample, a user comment, or a combination thereof.

32. The computer program of claim 27, wherein the laboratory manipulation includes a manipulation related to a nucleic acid preparation, a nucleic acid purification, a nucleic acid labeling, a protein preparation, a protein purification, a protein labeling, a metabolite preparation, a metabolite purification, or a metabolite labeling.

33. The computer program of claim 27, wherein the laboratory manipulation includes a gene expression profiling experiment, an ELISA-based assay, a cell-based assay, a flow cytometry assay, a multiplex bead-based assay, a proteomics assay, a PCR-based assay, a spectrophotometric analysis, a gel electrophoresis experiment, a capillary electrophoresis experiment, or a combination thereof.

34. The computer program of claim 27, wherein the laboratory manipulation includes a manipulation related to tissue homogenization, total RNA preparation, cRNA preparation, or hybridization of cRNA to a DNA array.

35. The computer program of claim 22, wherein the computer program includes instructions for causing a computer system to record on a computer-readable medium a comment from the first user when the second user disapproves of the first electronic record.

36. The computer program of claim 22, wherein the computer program includes instructions for causing a computer system to format the first computer-readable record for review by a regulatory agency.

37. The computer program of claim 22, wherein the computer program includes instructions for causing a computer system to recording on a computer-readable medium information entered by a first user to provide a second computer-readable record and metadata associated with the second computer-readable record to provide a collection of computer-readable records, wherein the metadata is protected from changes.

38. The computer program of claim 37, wherein the collection of computer-readable records is displayed to a second user for acknowledgement.

39. The computer program of claim 37, wherein the collection of computer-readable records describes a laboratory workflow.

40. The computer program of claim 37, wherein the computer program includes instructions for causing a computer system to modify the collection by recording on a computer-readable medium a third computer-readable record and metadata associated with the third computer-readable record, wherein the third computer-readable record corresponds to and modifies an existing computer-readable record in the collection, wherein the existing computer-readable record and its associated metadata are retained in the collection.

41. The computer program of claim 37, wherein the computer program includes instructions for causing a computer system to record on a computer-readable medium information entered by a first user to provide a plurality of computer-readable records and metadata associated with the each of the plurality of computer-readable records, to provide a collection of computer-readable records, wherein the metadata is protected from changes.

42. The computer program of claim 41, wherein the computer program includes instructions for causing a computer system to generate an audit trail for the collection of computer-readable records from the metadata.

43. A system for record-keeping, comprising:
a computer system configured to:
record on a computer-readable medium a plurality of information entered by a first user to provide a plurality computer-readable records, and metadata associated with the plurality of computer-readable records, wherein the information describes a laboratory manipulation carried out by the first user and the metadata is protected from changes;
display at least one of the plurality of computer-readable records to a second user for acknowledgement; and
record, on a computer-readable medium, an acknowledgement by the second user of information entered by the first user; and
a laboratory instrument in communication with the computer system, wherein the laboratory instrument is configured to communicate a result of a measurement to the computer system.

44. The system of claim 43, wherein the computer system is further configured record the result on the computer-readable medium to provide a second computer-readable record, and metadata associated with the second computer-readable record, wherein the metadata is protected from changes.

45. The system of claim 43, wherein the laboratory instrument includes a balance, a spectrophotometer, a spectrofluorometer, a centrifuge, a barcode reader, or a pipettor.

46. The system of claim 43, wherein the laboratory instrument includes a nucleic acid array reader.

47. The system of claim 43, wherein the laboratory manipulation is performed according to a standard operating procedure.

48. The system of claim 47, wherein the standard operating procedure specifies mandatory information describing the laboratory manipulation that must be recorded in order to comply with the standard operating procedure.

49. The system of claim 48, wherein the first user is required to enter the mandatory information.

50. The system of claim 43, wherein the computer system is configured to analyze the result.

51. The system of claim 43, wherein the computer system is configured to generate an audit trail for the plurality of computer-readable records from the metadata.

52. The system of claim 43, wherein the computer system is configured to format at least one of the plurality of computer-readable records for review by a regulatory agency.

53. The system of claim 43, wherein the computer system is configured to generate a report summarizing the plurality of computer-readable records.

54. The system of claim 53, wherein the computer system is further configured to store the report in an archive.
